(19) United States
(12) Patent Application Publication
(10) Pub. No.: US 2026/0038515 A1
(43) Pub. Date: Feb. 5, 2026

(54) SCENE AUDIO ENCODING METHOD AND ELECTRONIC DEVICE

(71) Applicant: HUAWEI TECHNOLOGIES CO., LTD., Shenzhen (CN)

(72) Inventors: Yuan GAO, Beijing (CN); Shuai LIU, Beijing (CN); Bing BU, Shenzhen (CN); Bingyin XIA, Beijing (CN); Zhe WANG, Beijing (CN)

(21) Appl. No.: 19/354,891

(22) Filed: Oct. 10, 2025

Related U.S. Application Data
(63) Continuation of application No. PCT/CN2024/071726, filed on Jan. 11, 2024.

(30) Foreign Application Priority Data
Apr. 13, 2023 (CN) 202310437050.5

(51) Int. Cl. G10L 19/008; H04S 7/00

(52) U.S. Cl. CPC G10L 19/008; H04S 7/30; H04S 2420/11

(57) ABSTRACT

Embodiments of this application provide a scene audio encoding method and an electronic device. The method includes: first, obtaining a scene audio signal; and then encoding the scene audio signal based on an encoding scheme combination. The encoding scheme combination includes at least one of the following combinations: a combination of a first encoding scheme, a second encoding scheme, and a third encoding scheme, or a combination of the first encoding scheme and the third encoding scheme. The first encoding scheme is to encode a signal. The second encoding scheme is a spatial encoding scheme. The third encoding scheme is an encoding scheme other than the first encoding scheme and the second encoding scheme. This can reduce bit rate overheads and encoding complexity while ensuring encoding quality to some extent.

### CROSS-REFERENCE TO RELATED APPLICATIONS

This application is a continuation of International Application No. PCT/CN2024/071726, filed on Jan. 11, 2024, which claims priority to Chinese Patent Application No. 202310437050.5, filed on Apr. 13, 2023. The disclosures of the aforementioned applications are hereby incorporated by reference in their entireties.

### TECHNICAL FIELD

Embodiments of this application relate to the audio encoding and decoding field, and in particular, to a scene audio encoding method and an electronic device.

### BACKGROUND

A three-dimensional audio technology is an audio technology for obtaining, processing, transmitting, rendering, and playing back sound events and three-dimensional sound field information in the real world through a computer, signal processing, or the like. Three-dimensional audio enables sound to have a strong sense of space, envelopment, and immersion, delivering extraordinary “immersive” auditory experience. A higher-order ambisonics (HOA) technology has the following characteristics: Recording, encoding, and playback stages are irrelevant to a speaker layout, and data in an HOA format is rotatably played back. Therefore, the HOA technology has higher flexibility in three-dimensional audio playback, and has gained more extensive attention and research.

A quantity of channels corresponding to an N^{th}-order HOA signal is (N+1)². With an increase in an HOA order, information for recording a more detailed sound scene in an HOA signal also increases accordingly. However, a data amount of the HOA signal also increases accordingly, creating challenges in both transmission and storage. Therefore, the HOA signal needs to be encoded and decoded. However, in the conventional technology, encoding performance of an HOA signal is low.

### SUMMARY

In view of this, this application provides a scene audio encoding method and an electronic device.

According to a first aspect, an embodiment of this application provides a scene audio encoding method. The method includes: first, obtaining a scene audio signal; and then encoding the scene audio signal based on an encoding scheme combination. The encoding scheme combination includes at least one of the following combinations: a combination of a first encoding scheme, a second encoding scheme, and a third encoding scheme, or a combination of the first encoding scheme and the third encoding scheme. The first encoding scheme is to encode a signal. The second encoding scheme is a spatial encoding scheme. The third encoding scheme is an encoding scheme other than the first encoding scheme and the second encoding scheme.

When the first encoding scheme is used for encoding, encoding quality can be improved, but high bit rate overheads are needed. When another encoding scheme (the second encoding scheme or the third encoding scheme) is used for encoding, bit rate overheads can be reduced, but encoding quality is degraded. Therefore, in this application, a combination of the first encoding scheme and another encoding scheme is used for encoding, to reduce bit rate overheads and encoding complexity while ensuring encoding quality to some extent.

For example, the scene audio signal in this embodiment of this application may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal.

For example, the scene audio signal may include audio signals of C channels, where C is a positive integer.

For example, when the scene audio signal is an HOA signal, the HOA signal may be an N^{th}-order HOA signal.

For example, the N^{th}-order HOA signal may include audio signals of C channels, where C=(N+1)². For example, when N=3, the N^{th}-order HOA signal includes audio signals of 16 channels; or when N=4, the N^{th}-order HOA signal includes audio signals of 25 channels.

For example, the first encoding scheme may also be referred to as a direct encoding scheme. To be specific, the signal is encoded by performing operations such as time-frequency transformation, preprocessing, bit allocation, quantization, and entropy encoding on the signal. It should be noted that encoding the signal is encoding a to-be-encoded signal (or data). For example, when the to-be-encoded signal is a scene audio signal, encoding the scene audio signal by using the first encoding scheme may be encoding audio signals of some or all of channels in the scene audio signal.

For example, the scene audio signal may include one or more frames.

According to the first aspect, the spatial encoding scheme is an encoding scheme for encoding attribute information of a target virtual speaker, and the attribute information of the target virtual speaker is determined based on the scene audio signal.

It should be noted that a location of the target virtual speaker matches a location of a sound source in the scene audio signal, a virtual speaker signal corresponding to the target virtual speaker may be generated based on the attribute information of the target virtual speaker and audio signals of some channels in the scene audio signal, and the scene audio signal may be reconstructed based on the virtual speaker signal. Therefore, an encoder encodes the audio signals of the channels in the scene audio signal and the attribute information of the target virtual speaker, and sends encoded information to a decoder. The decoder may reconstruct the scene audio signal based on reconstructed audio signals of the channels and the attribute information of the target virtual speaker that are obtained through decoding.

A data amount of the attribute information of the target virtual speaker is far less than a data amount of an audio signal of one channel. Therefore, compared with the first encoding scheme, the second encoding scheme needs lower bit rate overheads.

For example, the attribute information of the target virtual speaker includes at least one of the following: location information of the target virtual speaker, a location index corresponding to location information of the target virtual speaker, or a virtual speaker index of the target virtual speaker.

For example, in a spherical coordinate system, the location information of the target virtual speaker may be, for example, (θₛ₃, φₛ₃), where θₛ₃ is azimuth information of the target virtual speaker, and φₛ₃ is pitch information of the target virtual speaker.

For example, the location index is used to uniquely identify a location of a virtual speaker. The location index may include an azimuth index (used to uniquely identify one piece of azimuth information) and a pitch index (used to uniquely identify one piece of pitch information). Location indexes of virtual speakers are in a one-to-one correspondence with location information of virtual speakers.

For example, the virtual speaker index may be used to uniquely identify a virtual speaker. Location information or location indexes of virtual speakers are in a one-to-one correspondence with virtual speaker indexes.

According to any one of the first aspect or the foregoing implementations of the first aspect, the third encoding scheme includes one or more encoding schemes.

It should be understood that a type and a quantity of encoding schemes included in the third encoding scheme are not limited in this application. In this way, the third encoding scheme can be determined based on a current scenario (for example, content complexity of a scene audio signal and network bandwidth), to further improve encoding performance.

According to any one of the first aspect or the foregoing implementations of the first aspect, the third encoding scheme includes a channel copy encoding scheme. In this way, fluctuation of a reconstructed scene audio signal obtained through decoding can be reduced, to improve audio fluency.

According to any one of the first aspect or the foregoing implementations of the first aspect, the channel copy encoding scheme is a de-correlation encoding scheme. In this way, bit rate overheads needed by the third encoding scheme are lower than bit rate overheads needed by the second encoding scheme. Compared with a case in which the scene audio signal is encoded by using the combination of the first encoding scheme, the second encoding scheme, and the third encoding scheme, when the scene audio signal is encoded by using the combination of the first encoding scheme and the third encoding scheme, bit rate overheads and encoding complexity can be reduced.

According to any one of the first aspect or the foregoing implementations of the first aspect, encoding the scene audio signal based on the encoding scheme combination includes: encoding a frame of scene audio signal by using a plurality of encoding schemes in the encoding scheme combination. In this way, encoding quality of each frame of scene audio signal can be improved.

According to any one of the first aspect or the foregoing implementations of the first aspect, the scene audio signal includes X frames, the X frames include an i^{th} frame and a j^{th} frame, and encoding the scene audio signal based on the encoding scheme combination includes: encoding the i^{th} frame of scene audio signal by using a plurality of encoding schemes in the encoding scheme combination; and encoding the j^{th} frame of scene audio signal by using the first encoding scheme in the encoding scheme combination, where i and j are integers ranging from 1 to X, i is not equal to j, and X is a positive integer.

That is, some frames of scene audio signals are encoded by using a plurality of encoding schemes in the encoding scheme combination, and other frames of scene audio signals are encoded by using the first encoding scheme in the encoding scheme combination. This can flexibly adapt to encoding in various scenarios (for example, different content complexity of scene audio signals and different network bandwidth), and improve generalization of the scene audio encoding method in this application.

According to any one of the first aspect or the foregoing implementations of the first aspect, the scene audio signal includes X frames, the X frames include an i^{th} frame and a j^{th} frame, and encoding the scene audio signal based on the encoding scheme combination includes: encoding the i^{th} frame of scene audio signal by using a plurality of encoding schemes in a k1^{th} encoding scheme combination; and encoding the j^{th} frame of scene audio signal by using a plurality of encoding schemes in a k2^{th} encoding scheme combination, where i and j are positive integers ranging from 1 to X, i is not equal to j, k1 and k2 are positive integers, and k1 is not equal to k2.

That is, different frames of scene audio signals are encoded by using a plurality of encoding schemes in different encoding scheme combinations. This can flexibly adapt to encoding in various scenarios (for example, different content complexity of scene audio signals and different network bandwidth), and improve generalization of the scene audio encoding method in this application.

According to any one of the first aspect or the foregoing implementations of the first aspect, the frame of scene audio signal includes audio signals of C channels, and when the encoding scheme combination includes the combination of the first encoding scheme, the second encoding scheme, and the third encoding scheme, encoding the frame of scene audio signal by using the plurality of encoding schemes in the encoding scheme combination includes: for the frame of scene audio signal, encoding C1 first channels by using the first encoding scheme, encoding C2 second channels by using the second encoding scheme, and encoding C3 third channels by using the third encoding scheme, where C is equal to a sum of C1, C2, and C3, and C, C1, C2, and C3 are positive integers.

According to any one of the first aspect or the foregoing implementations of the first aspect, the frame of scene audio signal includes audio signals of C channels, an audio signal of a channel has Y frequency bands, and C and Y are positive integers; and encoding the frame of scene audio signal by using the plurality of encoding schemes in the encoding scheme combination includes: for the Y frequency bands of the channel in the frame of scene audio signal, performing encoding by using the plurality of encoding schemes in the encoding scheme combination.

For example, a frequency range of each frequency band may be set according to a requirement. This is not limited in this application.

According to any one of the first aspect or the foregoing implementations of the first aspect, the scene audio signal is an N^{th}-order higher-order ambisonics HOA signal;
the C1 first channels are C1 channels included in the 0^{th} order to an M^{th} order of the N^{th}-order HOA signal, where M is an integer less than N, C is equal to a square of (N+1), and C1 is less than or equal to a square of (M+1);
the C2 second channels include: other C4 channels included in the 0^{th} order to the M^{th} order of the N^{th}-order HOA signal, and C5 channels in the N^{th}-order HOA signal other than channels included in the 0^{th} order to the M^{th} order; and
the C3 third channels include: other C6 channels included in the 0^{th} order to the M^{th} order of the N^{th}-order HOA signal, and C7 channels in the N^{th}-order HOA signal other than the channels included in the 0^{th} order to the M^{th} order, where
C2 is equal to a sum of C4 and C5, C3 is equal to a sum of C6 and C7, a square of (M+1) is equal to a sum of C1, C4, and C6, and C4, C5, C6, and C7 are integers.

According to any one of the first aspect or the foregoing implementations of the first aspect, encoding the C3 third channels by using the third encoding scheme includes: encoding a first preset identifier corresponding to the C3 third channels, where the first preset identifier indicates that the third encoding scheme of the C3 third channels is a time-domain de-correlation encoding scheme or a frequency-domain de-correlation encoding scheme.

When the third encoding scheme is the time-domain de-correlation encoding scheme, the first preset identifier is a first preset value; or when the third encoding scheme is the frequency-domain de-correlation encoding scheme, the first preset identifier is a second preset value. In this way, the decoder can determine whether to use a time-domain de-correlation decoding scheme or a frequency-domain de-correlation decoding scheme for the C3 third channels.

Certainly, the encoder and the decoder may alternatively pre-agree upon whether the time-domain de-correlation decoding scheme (the time-domain de-correlation encoding scheme) or the frequency-domain de-correlation decoding scheme (the frequency-domain de-correlation encoding scheme) are to be used for the C3 third channels. This is not limited in this application.

According to any one of the first aspect or the foregoing implementations of the first aspect, when the encoding scheme combination is the combination of the first encoding scheme, the second encoding scheme, and the third encoding scheme, the method further includes: encoding feature information corresponding to the C2 second channels.

For example, feature information corresponding to a fifth audio signal in the scene audio signal may be determined based on energy, strength, or other information of the scene audio signal. For example, the feature information is gain information.

In this way, after obtaining the feature information from a bitstream through decoding, the decoder may compensate for reconstructed audio signals of the C2 second channels in a reconstructed scene audio signal, to improve audio quality of the reconstructed audio signals of the C2 second channels.

According to any one of the first aspect or the foregoing implementations of the first aspect, the method further includes: encoding a second preset identifier, where the second preset identifier indicates a type of the encoding scheme combination. In this way, the decoder can learn of a decoding scheme combination to be used for decoding.

Certainly, the encoder and the decoder may alternatively pre-agree upon the type of the encoding scheme combination. This is not limited in this application.

According to a second aspect, an embodiment of this application provides a scene audio decoding method. The decoding method includes: first, receiving a bitstream; and then decoding the bitstream based on a decoding scheme combination to obtain a reconstructed scene audio signal. The decoding scheme combination includes at least one of the following combinations: a combination of a first decoding scheme, a second decoding scheme, and a third decoding scheme, or a combination of the first decoding scheme and the third decoding scheme. The first decoding scheme is to decode encoded data that is obtained by encoding a signal. The second decoding scheme is a spatial decoding scheme. The third decoding scheme is a decoding scheme other than the first decoding scheme and the second decoding scheme.

Corresponding to a decoder, in this application, a combination of the first decoding scheme and another decoding scheme is used for decoding, to reduce decoding complexity while ensuring audio quality to some extent.

According to the second aspect, the spatial decoding scheme is a decoding scheme for performing reconstruction based on attribute information of a target virtual speaker, and the attribute information of the target virtual speaker is obtained from the bitstream through decoding.

According to any one of the second aspect or the foregoing implementations of the second aspect, the third decoding scheme includes one or more decoding schemes.

According to any one of the second aspect or the foregoing implementations of the second aspect, the third decoding scheme includes a channel copy decoding scheme.

According to any one of the second aspect or the foregoing implementations of the second aspect, the channel copy decoding scheme is a de-correlation decoding scheme.

In this way, when the third decoding scheme is the channel copy decoding scheme, fluctuation of the reconstructed scene audio signal obtained through decoding can be reduced, to improve audio fluency.

According to any one of the second aspect or the foregoing implementations of the second aspect, decoding the bitstream based on the decoding scheme combination to obtain the reconstructed scene audio signal includes:
decoding a frame of bitstream by using a plurality of decoding schemes in the decoding scheme combination to obtain a frame of reconstructed scene audio signal.

According to any one of the second aspect or the foregoing implementations of the second aspect, the bitstream includes X frames, the X frames include an i^{th} frame and a j^{th} frame, and decoding the bitstream based on the decoding scheme combination to obtain the reconstructed scene audio signal includes:
decoding the i^{th} frame of bitstream by using a plurality of decoding schemes in the decoding scheme combination to obtain an i^{th} frame of reconstructed scene audio signal; and
decoding the j^{th} frame of bitstream by using the first decoding scheme in the decoding scheme combination to obtain a j^{th} frame of reconstructed scene audio signal, where
i and j are integers ranging from 1 to X, i is not equal to j, and X is a positive integer.

According to any one of the second aspect or the foregoing implementations of the second aspect, the bitstream includes X frames, the X frames include an i^{th} frame and a j^{th} frame, and decoding the bitstream based on the decoding scheme combination to obtain the reconstructed scene audio signal includes:
decoding the i^{th} frame of bitstream by using a plurality of decoding schemes in a k1^{th} decoding scheme combination to obtain an i^{th} frame of reconstructed scene audio signal; and
decoding the j^{th} frame of bitstream by using a plurality of decoding schemes in a k2^{th} decoding scheme combination to obtain a j^{th} frame of reconstructed scene audio signal, where i and j are positive integers ranging from 1 to X, i is not equal to j, k1 and k2 are positive integers, and k1 is not equal to k2.

According to any one of the second aspect or the foregoing implementations of the second aspect, the frame of reconstructed scene audio signal includes reconstructed audio signals of C channels, and when the decoding scheme combination is the combination of the first decoding scheme, the second decoding scheme, and the third decoding scheme, decoding the frame of bitstream by using the plurality of decoding schemes in the decoding scheme combination to obtain the frame of reconstructed scene audio signal includes:
based on the frame of bitstream, decoding C1 first channels by using the first decoding scheme, decoding C2 second channels by using the second decoding scheme, and decoding C3 third channels by using the third decoding scheme, to obtain the frame of reconstructed scene audio signal, where
C is equal to a sum of C1, C2, and C3, and C, C1, C2, and C3 are positive integers.

According to any one of the second aspect or the foregoing implementations of the second aspect, the frame of reconstructed scene audio signal includes reconstructed audio signals of C channels, a reconstructed audio signal of a channel has Y frequency bands, and C and Y are positive integers; and
decoding the frame of bitstream by using the plurality of decoding schemes in the decoding scheme combination to obtain the frame of reconstructed scene audio signal includes:
for the Y frequency bands of the channel in the frame of reconstructed scene audio signal, decoding the frame of bitstream by using the plurality of decoding schemes in the decoding scheme combination to obtain the frame of reconstructed scene audio signal.

According to any one of the second aspect or the foregoing implementations of the second aspect, the reconstructed scene audio signal is an N^{th}-order higher-order ambisonics HOA signal;
the C1 first channels are C1 channels included in the 0^{th} order to an M^{th} order of the N^{th}-order HOA signal, where M is an integer less than N, C is equal to a square of (N+1), and C1 is less than or equal to a square of (M+1);
the C2 second channels include: other C4 channels included in the 0^{th} order to the M^{th} order of the N^{th}-order HOA signal, and C5 channels in the N^{th}-order HOA signal other than channels included in the 0^{th} order to the M^{th} order; and
the C3 third channels include: other C6 channels included in the 0^{th} order to the M^{th} order of the N^{th}-order HOA signal, and C7 channels in the N^{th}-order HOA signal other than the channels included in the 0^{th} order to the M^{th} order, where
C2 is equal to a sum of C4 and C5, C3 is equal to a sum of C6 and C7, a square of (M+1) is equal to a sum of C1, C4, and C6, and C4, C5, C6, and C7 are integers.

According to any one of the second aspect or the foregoing implementations of the second aspect, decoding the C3 third channels by using the third decoding scheme includes: decoding the C3 third channels based on the third decoding scheme that corresponds to a first preset identifier parsed out from the bitstream, where the third decoding scheme corresponding to the first preset identifier is a time-domain de-correlation decoding scheme or a frequency-domain de-correlation decoding scheme.

According to any one of the second aspect or the foregoing implementations of the second aspect, when the decoding scheme combination is the combination of the first decoding scheme, the second decoding scheme, and the third decoding scheme, the method further includes:
compensating for reconstructed audio signals of the C2 second channels in the reconstructed scene audio signal based on feature information that corresponds to the C2 second channels and that is parsed out from the bitstream.

According to any one of the second aspect or the foregoing implementations of the second aspect, the method further includes:
parsing out a second preset identifier from the bitstream; and
decoding the bitstream based on the decoding scheme combination to obtain the reconstructed scene audio signal includes:
decoding the bitstream based on a decoding scheme combination corresponding to the second preset identifier, to obtain the reconstructed scene audio signal.

Any one of the second aspect or the implementations of the second aspect corresponds to any one of the first aspect or the implementations of the first aspect. For technical effects corresponding to any one of the second aspect or the implementations of the second aspect, refer to technical effects corresponding to any one of the first aspect or the implementations of the first aspect.

According to a third aspect, an embodiment of this application provides a bitstream generation method. In the method, a bitstream may be generated according to any one of the first aspect or the implementations of the first aspect.

Any one of the third aspect or the implementations of the third aspect corresponds to any one of the first aspect or the implementations of the first aspect. For technical effects corresponding to any one of the third aspect or the implementations of the third aspect, refer to technical effects corresponding to any one of the first aspect or the implementations of the first aspect.

According to a fourth aspect, an embodiment of this application provides a scene audio encoding apparatus. The apparatus includes:
a signal obtaining module, configured to obtain a to-be-encoded scene audio signal; and
an encoding module, configured to encode the scene audio signal based on an encoding scheme combination, where the encoding scheme combination includes at least one of the following combinations: a combination of a first encoding scheme, a second encoding scheme, and a third encoding scheme, or a combination of the first encoding scheme and the third encoding scheme; the first encoding scheme is to encode a signal; the second encoding scheme is a spatial encoding scheme; and the third encoding scheme is an encoding scheme other than the first encoding scheme and the second encoding scheme.

The scene audio encoding apparatus in the fourth aspect may perform the steps in any one of the first aspect or the implementations of the first aspect.

In addition, the scene audio encoding apparatus in the fourth aspect may further include a communication module.

Any one of the fourth aspect or the implementations of the fourth aspect corresponds to any one of the first aspect or the implementations of the first aspect. For technical effects corresponding to any one of the fourth aspect or the implementations of the fourth aspect, refer to technical effects corresponding to any one of the first aspect or the implementations of the first aspect.

According to a fifth aspect, an embodiment of this application provides a scene audio decoding apparatus. The apparatus includes:
a bitstream receiving module, configured to receive a bitstream; and
a decoding module, configured to decode a bitstream based on a decoding scheme combination to obtain a reconstructed scene audio signal, where
the decoding scheme combination includes at least one of the following combinations: a combination of a first decoding scheme, a second decoding scheme, and a third decoding scheme, or a combination of the first decoding scheme and the third decoding scheme; the first decoding scheme is to decode encoded data that is obtained by encoding a signal; the second decoding scheme is a spatial decoding scheme; and the third decoding scheme is a decoding scheme other than the first decoding scheme and the second decoding scheme.

The scene audio decoding apparatus in the fifth aspect may perform the steps in any one of the second aspect or the implementations of the second aspect.

In addition, the scene audio decoding apparatus in the fifth aspect may further include a communication module.

Any one of the fifth aspect or implementations of the fifth aspect corresponds to any one of the second aspect or the implementations of the second aspect. For technical effects corresponding to any one of the fifth aspect or the implementations of the fifth aspect, refer to technical effects corresponding to any one of the second aspect or the implementations of the second aspect.

According to a sixth aspect, an embodiment of this application provides an electronic device, including a memory and a processor. The memory is coupled to the processor. The memory stores program instructions. When the program instructions are executed by the processor, the electronic device is enabled to perform the scene audio encoding method according to any one of the first aspect or the possible implementations of the first aspect.

Any one of the sixth aspect or the implementations of the sixth aspect corresponds to any one of the first aspect or the implementations of the first aspect. For technical effects corresponding to any one of the sixth aspect or the implementations of the sixth aspect, refer to technical effects corresponding to any one of the first aspect or the implementations of the first aspect.

According to a seventh aspect, an embodiment of this application provides an electronic device, including a memory and a processor. The memory is coupled to the processor. The memory stores program instructions. When the program instructions are executed by the processor, the electronic device is enabled to perform the scene audio decoding method according to any one of the second aspect or the possible implementations of the second aspect.

Any one of the seventh aspect or the implementations of the seventh aspect corresponds to any one of the second aspect or the implementations of the second aspect. For technical effects corresponding to any one of the seventh aspect or the implementations of the seventh aspect, refer to technical effects corresponding to any one of the second aspect or the implementations of the second aspect.

According to an eighth aspect, an embodiment of this application provides a chip, including one or more interface circuits and one or more processors. The one or more processors send or receive data through the one or more interface circuits. When the one or more processors execute computer instructions, an electronic device is enabled to perform the scene audio encoding method according to any one of the first aspect or the possible implementations of the first aspect.

Any one of the eighth aspect or the implementations of the eighth aspect corresponds to any one of the first aspect or the implementations of the first aspect. For technical effects corresponding to any one of the eighth aspect or the implementations of the eighth aspect, refer to technical effects corresponding to any one of the first aspect or the implementations of the first aspect.

According to a ninth aspect, an embodiment of this application provides a chip, including one or more interface circuits and one or more processors. The one or more processors send or receive data through the one or more interface circuits. When the one or more processors execute computer instructions, an electronic device is enabled to perform the scene audio decoding method according to any one of the second aspect or the possible implementations of the second aspect.

Any one of the ninth aspect or the implementations of the ninth aspect corresponds to any one of the second aspect or the implementations of the second aspect. For technical effects corresponding to any one of the ninth aspect or the implementations of the ninth aspect, refer to technical effects corresponding to any one of the second aspect or the implementations of the second aspect.

According to a tenth aspect, an embodiment of this application provides a computer-readable storage medium. The computer-readable storage medium stores a computer program. When the computer program is run on a computer or a processor, the computer or the processor is enabled to perform the scene audio encoding method according to any one of the first aspect or the possible implementations of the first aspect.

Any one of the tenth aspect or the implementations of the tenth aspect corresponds to any one of the first aspect or the implementations of the first aspect. For technical effects corresponding to any one of the tenth aspect or the implementations of the tenth aspect, refer to technical effects corresponding to any one of the first aspect or the implementations of the first aspect.

According to an eleventh aspect, an embodiment of this application provides a computer-readable storage medium. The computer-readable storage medium stores a computer program. When the computer program is run on a computer or a processor, the computer or the processor is enabled to perform the scene audio decoding method according to any one of the second aspect or the possible implementations of the second aspect.

Any one of the eleventh aspect or the implementations of the eleventh aspect corresponds to any one of the second aspect or the implementations of the second aspect. For technical effects corresponding to any one of the eleventh aspect or the implementations of the eleventh aspect, refer to technical effects corresponding to any one of the second aspect or the implementations of the second aspect.

According to a twelfth aspect, an embodiment of this application provides a computer program product. The computer program product includes a software program. When the software program is executed by a computer or a processor, the computer or the processor is enabled to perform the scene audio encoding method according to any one of the first aspect or the possible implementations of the first aspect.

Any one of the twelfth aspect or the implementations of the twelfth aspect corresponds to any one of the first aspect or the implementations of the first aspect. For technical effects corresponding to any one of the twelfth aspect or the implementations of the twelfth aspect, refer to technical effects corresponding to any one of the first aspect or the implementations of the first aspect.

According to a thirteenth aspect, an embodiment of this application provides a computer program product. The computer program product includes a software program. When the software program is executed by a computer or a processor, the computer or the processor is enabled to perform the scene audio decoding method according to any one of the second aspect or the possible implementations of the second aspect.

Any one of the thirteenth aspect or the implementations of the thirteenth aspect corresponds to any one of the second aspect or the implementations of the second aspect. For technical effects corresponding to any one of the thirteenth aspect or the implementations of the thirteenth aspect, refer to technical effects corresponding to any one of the second aspect or the implementations of the second aspect.

According to a fourteenth aspect, an embodiment of this application provides a bitstream storage apparatus. The apparatus includes a receiver and at least one storage medium. The receiver is configured to receive a bitstream. The at least one storage medium is configured to store the bitstream. The bitstream is generated according to any one of the first aspect or the implementations of the first aspect.

Any one of the fourteenth aspect or the implementations of the fourteenth aspect corresponds to any one of the first aspect or the implementations of the first aspect. For technical effects corresponding to any one of the fourteenth aspect or the implementations of the fourteenth aspect, refer to technical effects corresponding to any one of the first aspect or the implementations of the first aspect.

According to a fifteenth aspect, an embodiment of this application provides a bitstream transmission apparatus. The apparatus includes a transmitter and at least one storage medium. The at least one storage medium is configured to store a bitstream. The bitstream is generated according to any one of the first aspect or the implementations of the first aspect. The transmitter is configured to receive the bitstream from the storage medium, and send the bitstream to a device-side device through a transmission medium.

Any one of the fifteenth aspect or the implementations of the fifteenth aspect corresponds to any one of the first aspect or the implementations of the first aspect. For technical effects corresponding to any one of the fifteenth aspect or the implementations of the fifteenth aspect, refer to technical effects corresponding to any one of the first aspect or the implementations of the first aspect.

According to sixteenth aspect, an embodiment of this application provides a bitstream delivery system. The system includes: at least one storage medium, configured to store at least one bitstream, where the at least one bitstream is generated according to any one of the first aspect or the implementations of the first aspect; and a streaming media device, configured to obtain a target bitstream from the at least one storage medium, and send the target bitstream to a device-side device, where the streaming media device includes a content server or a content delivery server.

Any one of the sixteenth aspect or the implementations of the sixteenth aspect corresponds to any one of the first aspect or the implementations of the first aspect. For technical effects corresponding to any one of the sixteenth aspect or the implementations of the sixteenth aspect, refer to technical effects corresponding to any one of the first aspect or the implementations of the first aspect.

### BRIEF DESCRIPTION OF DRAWINGS

FIG. 1a is a diagram of an example application scenario;

FIG. 1b is a diagram of an example application scenario;

FIG. 2 is a diagram of an example scene audio signal encoding process;

FIG. 3 is a diagram of an example scene audio signal decoding process;

FIG. 4a is a diagram of an example scene audio signal encoding process;

FIG. 4b is a diagram of example distribution of candidate virtual speakers;

FIG. 5 is a diagram of an example scene audio signal decoding process;

FIG. 6 is a diagram of an example scene audio signal encoding process;

FIG. 7 is a diagram of an example scene audio signal decoding process;

FIG. 8 is a diagram of an example scene audio signal encoding process;

FIG. 9 is a diagram of an example scene audio signal decoding process; and

FIG. 10 is a diagram of an example structure of an apparatus.

### DESCRIPTION OF EMBODIMENTS

The following clearly describes the technical solutions in embodiments of this application with reference to the accompanying drawings in embodiments of this application. Clearly, the described embodiments are some but not all of embodiments of this application. All other embodiments obtained by a person of ordinary skill in the art based on embodiments of this application without creative efforts shall fall within the protection scope of this application.

The term “and/or” in this specification describes only an association relationship between associated objects, and indicates that three relationships may exist. For example, A and/or B may indicate the following three cases: Only A exists, both A and B exist, and only B exists.

In this specification and the claims of embodiments of this application, the terms “first”, “second”, and the like are intended to distinguish between different objects, but not to indicate a specific order of the objects. For example, a first target object and a second target object are intended to distinguish between different target objects, but not to indicate a specific order of the target objects.

In embodiments of this application, the term “in an example”, “for example”, or the like is used to give an example, an illustration, or a description. Any embodiment or implementation scheme described with “in an example” or “for example” in embodiments of this application should not be construed as being more preferred or advantageous than another embodiment or implementation scheme. To be precise, the term “in an example”, “for example”, or the like is intended to present a related concept in a specific manner.

In descriptions of embodiments of this application, “a plurality of” means two or more, unless otherwise specified. For example, a plurality of processing units are two or more processing units, and a plurality of systems are two or more systems.

For clarity and brevity of description of the following embodiments, a related technology is first briefly described.

Sound is a continuous wave generated by an object through vibration. An object that vibrates to produce a sound wave is referred to as a sound source. During propagation of the sound wave through a medium (for example, air, solid, or liquid), an auditory organ of a human or an animal can sense sound.

Features of the sound wave include a tone, intensity, and a timbre. The tone indicates a level of the sound. The intensity indicates a volume of the sound. The intensity may also be referred to as loudness or a volume. A unit of the intensity is decibel (dB). The timbre is also referred to as sound quality.

A frequency of the sound wave determines a level of the tone. A higher frequency indicates a higher tone. A quantity of times that the object vibrates within 1 second is referred to as a frequency, and a unit of the frequency is hertz (Hz). A frequency of sound that can be recognized by a human ear ranges from 20 Hz to 20000 Hz.

An amplitude of the sound wave determines the intensity. A larger amplitude indicates higher intensity. A shorter distance from the sound source indicates higher intensity.

A waveform of the sound wave determines the timbre. The waveform of the sound wave includes a square wave, a sawtooth wave, a sine wave, a pulse wave, and the like.

Sound may be classified into regular sound and irregular sound based on the features of the sound wave. The irregular sound is sound produced by a sound source through irregular vibration. The irregular sound is, for example, noise that affects people's work, study, rest, and the like. The regular sound is sound produced by a sound source through regular vibration. The regular sound includes voice and music. When the sound is represented electrically, the regular sound is an analog signal that changes continuously in time-frequency domain. The analog signal may be referred to as an audio signal. The audio signal is an information carrier that carries voice, music, and sound effect.

A human auditory sense has a capability of distinguishing location distribution of a sound source in space. Therefore, when hearing sound in space, a listener can sense a direction and a location of the sound in addition to a tone, intensity, and a timbre of the sound.

As people pay increasing attention to auditory system experience and have increasingly high requirements for quality, a three-dimensional audio technology emerges, to enhance a sense of depth, a sense of immersion, and a sense of space of sound. In this way, a listener not only feels sound produced by sound sources from the front, rear, left, and right, but also feels that space in which the listener is located is surrounded by a spatial sound field (“sound field” for short) produced by the sound sources, and feels that the sound spreads around. This creates “immersive” sound effect that enables the listener to feel like being in a cinema, a concert hall, or the like.

A scene audio signal in embodiments of this application may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal. The HOA signal is used below as an example for description.

It is well known that, when a sound wave is propagated in an ideal medium, a wave number is k=w/c, and an angular frequency is w=2πf, where f is a frequency of the sound wave, and c is a sound velocity. Sound pressure P satisfies a formula (1), where ∇² is a Laplace operator.

$${∇}^{2} p + {k}^{2} p = 0 \qquad ( 1 )$$

It is assumed that a spatial system outside a human ear is a sphere, and a listener is at a center of the sphere. Sound transmitted from the outside of the sphere has a projection on a spherical surface, and sound outside the spherical surface is filtered out. It is assumed that a sound source is distributed on the spherical surface, and a sound field produced by the sound source on the spherical surface fits a sound field produced by an original sound source. That is, the three-dimensional audio technology is a sound field fitting method. For example, the equation in the formula (1) is solved in a spherical coordinate system. In a passive spherical area, a solution to the equation in the formula (1) is the following formula (2):

$$p ( r , θ , φ , k ) = s {\sum }_{m = 0}^{∞} ( 2 m + 1 ) {j}^{m} {j}_{m}^{kr} ( kr ) {\sum }_{0 \leq n \leq m , σ = \pm 1} {Y}_{m , n}^{σ} ( {θ}_{s} , {φ}_{s} ) {Y}_{m , n}^{σ} ( θ , φ ) \qquad ( 2 )$$

r indicates a radius of the sphere, θ indicates azimuth angle information (or referred to as azimuth information), φ indicates pitch angle information (or referred to as pitch information), k indicates a wave number, s indicates an amplitude of an ideal plane wave, and m indicates a sequence number of an order of an HOA signal (or referred to as a number of an order of an HOA signal).

$${j}^{m} {j}_{m}^{kr} ( kr )$$

indicates a spherical Bessel function, and the spherical Bessel function is also referred to as a radial basis function, where the 1^{st} j indicates an imaginary unit, and

$$( 2 m + 1 ) {j}^{m} {j}_{m}^{kr} ( kr )$$

does not change with an angle

$${Y}_{m , n}^{σ} ( θ , φ )$$

indicates a spherical harmonic function in θ and φ directions, and

$${Y}_{m , n}^{σ} ( {θ}_{s} , {φ}_{s} )$$

indicates a spherical harmonic function in a sound source direction. The HOA signal satisfies a formula (3).

$${B}_{m , n}^{σ} = s \cdot {Y}_{m , n}^{σ} ( {θ}_{s} , {φ}_{s} ) \qquad ( 3 )$$

The formula (3) is substituted into the formula (2), and the formula (2) may be transformed into a formula (4).

$$p ( r , θ , φ , k ) = {\sum }_{m = 0}^{∞} {j}^{m} {j}_{m}^{kr} ( kr ) {\sum }_{0 \leq n \leq m , σ \pm 1} {B}_{m , n}^{σ} {Y}_{m , n}^{σ} ( θ , φ ) \qquad ( 4 )$$

m is truncated to an N^{th} term, that is, m=N, and

$${B}_{m , n}^{σ}$$

is used as an approximate description of the sound field. In this case,

$${B}_{m , n}^{σ}$$

may be referred to as an HOA coefficient (which may represent an N^{th}-order HOA signal). The sound field is an area in which a sound wave exists in a medium. N is an integer greater than or equal to 1.

The scene audio signal is an information carrier that carries spatial location information of a sound source in a sound field, and describes a sound field of a listener in space. The formula (4) indicates that the sound field may be expanded on a spherical surface based on a spherical harmonic function. In other words, the sound field may be decomposed into superposition of a plurality of plane waves. Therefore, the sound field described by the HOA signal may be expressed through superposition of a plurality of plane waves, and the sound field is reconstructed by using the HOA coefficient.

A to-be-encoded HOA signal in embodiments of this application may be an N^{th}-order HOA signal, and may be represented by an HOA coefficient or an ambisonics (ambisonics) coefficient, where N is an integer greater than or equal to 1 (when N is equal to 1, a first-order HOA signal may be referred to as an FOA (First-Order Ambisonics, first-order ambisonics) signal). The N^{th}-order HOA signal includes audio signals of (N+1)² channels.

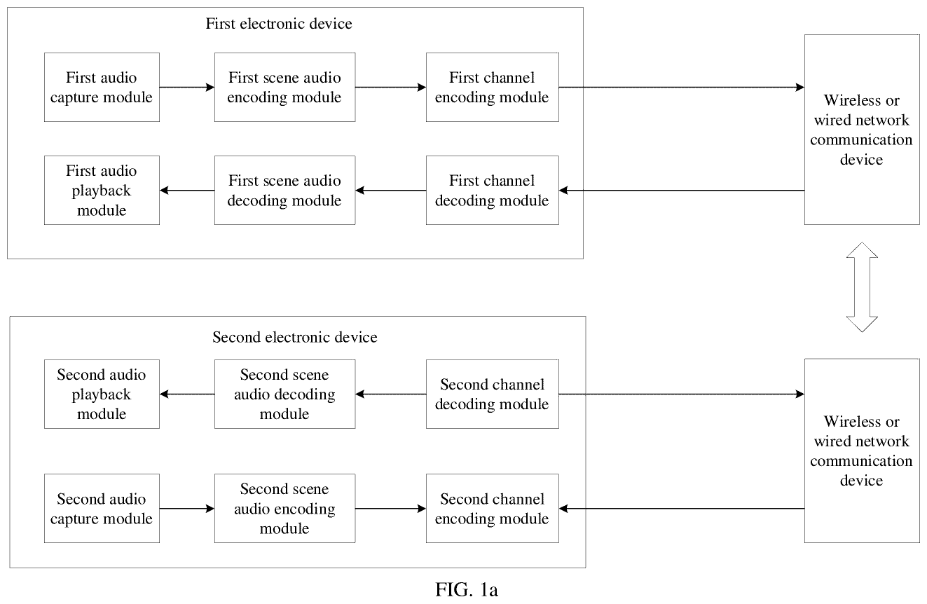

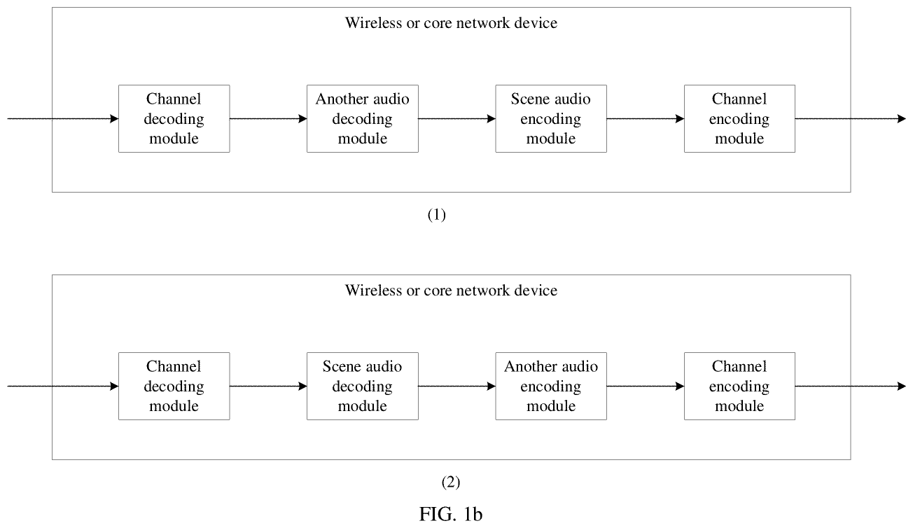

FIG. 1a is a diagram of an example application scenario. FIG. 1a shows a scenario of encoding and decoding a scene audio signal.

As shown in FIG. 1a, for example, a first electronic device may include a first audio capture module, a first scene audio encoding module, a first channel encoding module, a first channel decoding module, a first scene audio decoding module, and a first audio playback module. It should be understood that the first electronic device may include more or fewer modules than those shown in FIG. 1a. This is not limited in this application.

As shown in FIG. 1a, for example, a second electronic device may include a second audio capture module, a second scene audio encoding module, a second channel encoding module, a second channel decoding module, a second scene audio decoding module, and a second audio playback module. It should be understood that the second electronic device may include more or fewer modules than those shown in FIG. 1a. This is not limited in this application.

For example, a process in which the first electronic device encodes a scene audio signal and transmits an encoded signal to the second electronic device, and the second electronic device performs decoding and audio playback may be as follows: The first audio capture module may capture audio, and output a scene audio signal to the first scene audio encoding module. Then the first scene audio encoding module may encode the scene audio signal, and output a bitstream to the first channel encoding module. Then the first channel encoding module may perform channel encoding on the bitstream, and transmit, to the second electronic device through a wireless or wired network communication device, a bitstream obtained through channel encoding. Then the second channel decoding module of the second electronic device may perform channel decoding on received data to obtain a bitstream, and output the bitstream to the second scene audio decoding module. Then the second scene audio decoding module may decode the bitstream to obtain a reconstructed scene audio signal, and then output the reconstructed scene audio signal to the second audio playback module, and the second audio playback module performs audio playback.

It should be noted that the second audio playback module may perform post-processing (for example, audio rendering (for example, may convert a reconstructed scene audio signal including audio signals of (N+1)² channels into audio signals of channels whose quantity is the same as a quantity of speakers in the second electronic device), loudness normalization, user interaction, audio format conversion, or noise reduction) on the reconstructed scene audio signal, to convert the reconstructed scene audio signal into an audio signal suitable for playing by a speaker in the second electronic device.

It should be understood that a process in which the second electronic device encodes a scene audio signal and transmits an encoded signal to the first electronic device, and the first electronic device performs decoding and audio playback is similar to the foregoing process in which the first electronic device transmits a scene audio signal to the second electronic device, and the second electronic device performs audio playback.

For example, the first electronic device and the second electronic device each may include but are not limited to a personal computer, a computer workstation, a smartphone, a tablet computer, a server, a smart camera, an intelligent vehicle, another type of cellular phone, a media consumption device, a wearable device, a set-top box, a game console, and the like.

For example, this application may be applied to a VR (virtual reality)/AR (augmented Reality) scenario. In a possible manner, the first electronic device is a server, and the second electronic device is a VR/AR device. In a possible manner, the second electronic device is a server, and the first electronic device is a VR/AR device.

For example, the first scene audio encoding module and the second scene audio encoding module may be scene audio encoders. The first scene audio decoding module and the second scene audio decoding module may be scene audio decoders.

For example, when the first electronic device encodes a scene audio signal and the second electronic device reconstructs a scene audio signal, the first electronic device may be referred to as an encoder, and the second electronic device may be referred to as a decoder. When the second electronic device encodes a scene audio signal and the first electronic device reconstructs a scene audio signal, the second electronic device may be referred to as an encoder, and the first electronic device may be referred to as a decoder.

FIG. 1b is a diagram of an example application scenario. FIG. 1b shows a scene audio signal transcoding scenario.

As shown in (1) in FIG. 1b, for example, a wireless or core network device may include a channel decoding module, another audio decoding module, a scene audio encoding module, and a channel encoding module. The wireless or core network device may be configured to perform audio transcoding.

For example, a specific application scenario in (1) in FIG. 1b may be as follows: A first electronic device is not provided with a scene audio encoding module, and is provided with only another audio encoding module. A second electronic device is provided with only a scene audio decoding module, and is not provided with another audio decoding module. The wireless or core network device may be used for transcoding, to enable the second electronic device to decode and play back a scene audio signal encoded by the first electronic device by using the another audio encoding module.

For example, the first electronic device encodes a scene audio signal by using the another audio encoding module to obtain a first bitstream, performs channel encoding on the first bitstream, and then sends a first bitstream obtained through channel encoding to the wireless or core network device. Then the channel decoding module of the wireless or core network device may perform channel decoding, and output, to the another audio decoding module, a first bitstream obtained through channel decoding. Then the another audio decoding module decodes the first bitstream to obtain a scene audio signal, and outputs the scene audio signal to the scene audio encoding module. Then the scene audio encoding module may encode the scene audio signal to obtain a second bitstream, and output the second bitstream to the channel encoding module. The channel encoding module performs channel encoding on the second bitstream, and then sends a second bitstream obtained through channel encoding to the second electronic device. In this way, the second electronic device may invoke the scene audio decoding module to decode a second bitstream obtained through channel decoding, to obtain a reconstructed scene audio signal; and subsequently, may perform audio playback on the reconstructed scene audio signal.

As shown in (2) in FIG. 1b, for example, a wireless or core network device may include a channel decoding module, a scene audio decoding module, another audio encoding module, and a channel encoding module. The wireless or core network device may be configured to perform audio transcoding.

For example, a specific application scenario in (2) in FIG. 1b may be as follows: A first electronic device is provided only with a scene audio encoding module, and is not provided with another audio encoding module. A second electronic device is not provided with a scene audio decoding module, and is provided only with another audio decoding module. The wireless or core network device may be used for transcoding, to enable the second electronic device to decode and play back a scene audio signal encoded by the first electronic device by using the scene audio encoding module.

For example, the first electronic device encodes a scene audio signal by using the scene audio encoding module to obtain a first bitstream, performs channel encoding on the first bitstream, and then sends a first bitstream obtained through channel encoding to the wireless or core network device. Then the channel decoding module of the wireless or core network device may perform channel decoding, and output, to the scene audio decoding module, a first bitstream obtained through channel decoding. Then the scene audio decoding module decodes the first bitstream to obtain a scene audio signal, and outputs the scene audio signal to the another audio encoding module. Then the another audio encoding module may encode the scene audio signal to obtain a second bitstream, and output the second bitstream to the channel encoding module. The channel encoding module performs channel encoding on the second bitstream, and then sends a second bitstream obtained through channel encoding to the second electronic device. In this way, the second electronic device may invoke the another audio decoding module to decode a second bitstream obtained through channel decoding, to obtain a reconstructed scene audio signal; and subsequently, may perform audio playback on the reconstructed scene audio signal.

The following describes encoding and decoding processes of a scene audio signal.

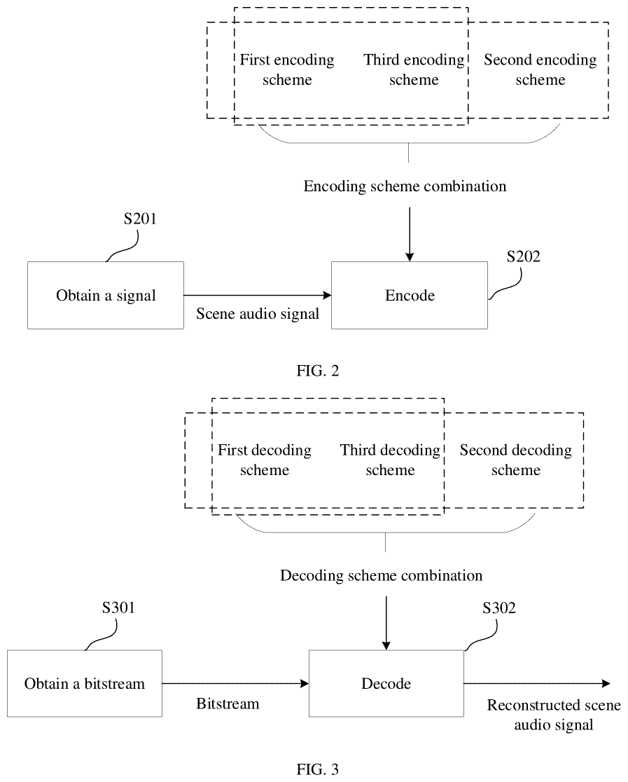

FIG. 2 is a diagram of an example scene audio signal encoding process.

S201: Obtain a scene audio signal.

For example, a to-be-encoded scene audio signal may be obtained, where the scene audio signal may include audio signals of C channels, and C is a positive integer.

For example, when the scene audio signal is an HOA signal, the HOA signal may be an N^{th}-order HOA signal, to be specific,

$${B}_{m , n}^{σ}$$

in the foregoing formula (3) in a case in which m is truncated to an N^{th} term.

For example, the N^{th}-order HOA signal may include audio signals of C channels, where C=(N+1)². For example, when N=3, the N^{th}-order HOA signal includes audio signals of 16 channels; or when N=4, the N^{th}-order HOA signal includes audio signals of 25 channels.

For example, the scene audio signal may include one or more frames.

S202: Encode the scene audio signal based on an encoding scheme combination.

For example, the scene audio signal may be encoded by using an encoding scheme combination including a plurality of encoding schemes, to obtain a bitstream of the scene audio signal.

In a possible manner, the encoding scheme combination may include a first encoding scheme, a second encoding scheme, and a third encoding scheme.

In a possible manner, the encoding scheme combination may include a first encoding scheme and a third encoding scheme.

For example, in the first encoding scheme, a signal may be encoded. To be specific, operations such as time-frequency transformation, preprocessing, bit allocation, quantization, and entropy encoding are performed on the signal. The first encoding scheme may also be referred to as a direct encoding scheme.

For example, the second encoding scheme may be a spatial encoding scheme. In the spatial encoding scheme, attribute information of a target virtual speaker that is determined based on the scene audio signal is encoded. A process of determining the attribute information of the target virtual speaker based on the scene audio signal is described below.

For example, the third encoding scheme may include one or more encoding schemes other than the first encoding scheme and the second encoding scheme.

In a possible manner, the third encoding scheme is channel copy (or HOA copy) encoding. Optionally, the third encoding scheme is a de-correlation encoding scheme. It should be understood that a quantity and a type of encoding schemes included in the third encoding scheme are not limited in this application.

It should be understood that the encoding scheme combination includes at least one of the following combinations: a combination of the first encoding scheme and the third encoding scheme, or a combination of the first encoding scheme, the second encoding scheme, and the third encoding scheme.

When the direct encoding scheme (namely, the first encoding scheme) is used for encoding, encoding quality can be improved, but high bit rate overheads are needed. When another encoding scheme (the second encoding scheme or the third encoding scheme) is used for encoding, bit rate overheads can be reduced, but encoding quality is degraded. Therefore, in this application, a combination of the direct encoding scheme and another encoding scheme is used for encoding, to reduce bit rate overheads and encoding complexity while ensuring encoding quality to some extent.

When bit rate overheads needed by the third encoding scheme are lower than bit rate overheads needed by the second encoding scheme, for example, when the third encoding scheme is the channel copy encoding scheme, compared with a case in which the scene audio signal is encoded by using the combination of the first encoding scheme, the second encoding scheme, and the third encoding scheme, in this application, the scene audio signal is encoded by using the combination of the first encoding scheme and the third encoding scheme, to reduce bit rate overheads and encoding complexity.

In a possible manner, an encoder and a decoder may pre-agree upon a type of an encoding scheme combination (or a decoding scheme combination).

In a possible manner, an encoder and a decoder do not pre-agree upon a type of an encoding scheme combination (or a decoding scheme combination). In this case, the encoder may further encode a second preset identifier, where the second preset identifier may indicate a type of an encoding scheme combination (or a decoding scheme combination). In this way, after the second preset identifier is transmitted to the decoder by using a bitstream, the decoder may learn of the type of the encoding scheme combination (or the decoding scheme combination), and perform decoding by using a decoding scheme combination corresponding to the encoding scheme combination of the encoder, to obtain a reconstructed scene audio signal.

FIG. 3 is a diagram of an example scene audio decoding process. The embodiment of FIG. 3 is a decoding process corresponding to the encoding process in the embodiment of FIG. 2.

S301: Receive a bitstream.

S302: Decode the bitstream based on a decoding scheme combination to obtain a reconstructed scene audio signal.

For example, the bitstream may be decoded by using a decoding scheme combination including a plurality of decoding schemes, to obtain the reconstructed scene audio signal.

In a possible manner, the decoding scheme combination may include a first decoding scheme, a second decoding scheme, and a third decoding scheme.

In a possible manner, the decoding scheme combination may include a first decoding scheme and a third decoding scheme.

For example, in the first decoding scheme, encoded data obtained by encoding a signal may be decoded. To be specific, operations such as entropy decoding, dequantization, bit allocation, post-processing, and time-frequency transformation are performed on the encoded data obtained by encoding the signal. The first decoding scheme may also be referred to as a direct decoding scheme.

For example, the second decoding scheme may be a spatial decoding scheme. In the spatial decoding scheme, reconstruction is performed based on attribute information of a target virtual speaker. A process of performing reconstruction based on the attribute information of the target virtual speaker is described below.

For example, the third decoding scheme may include one or more decoding schemes other than the first decoding scheme and the second decoding scheme. In a possible manner, the third decoding scheme may be channel copy (HOA copy) decoding. Optionally, the third decoding scheme is a de-correlation decoding scheme. It should be understood that a quantity and a type of decoding schemes included in the third decoding scheme are not limited in this application.

It should be understood that the decoding scheme combination includes at least one of the following combinations: a combination of the first decoding scheme and the third decoding scheme, or a combination of the first decoding scheme, the second decoding scheme, and the third decoding scheme.

For example, when an encoder and a decoder pre-agree upon a type of an encoding scheme combination (a decoding scheme combination), the decoder may decode the bitstream by using the pre-agreed-upon decoding scheme combination, to obtain the reconstructed scene audio signal.

For example, when an encoder and a decoder do not pre-agreed upon a type of an encoding scheme combination (or a decoding scheme combination), the decoder may first parse the bitstream to obtain the second preset identifier, and then decode the bitstream based on a decoding scheme combination corresponding to the second preset identifier, to obtain the reconstructed scene audio signal.

In this way, when the third decoding scheme is the channel copy decoding scheme, fluctuation of the reconstructed scene audio signal obtained through decoding can be reduced, to improve audio fluency.

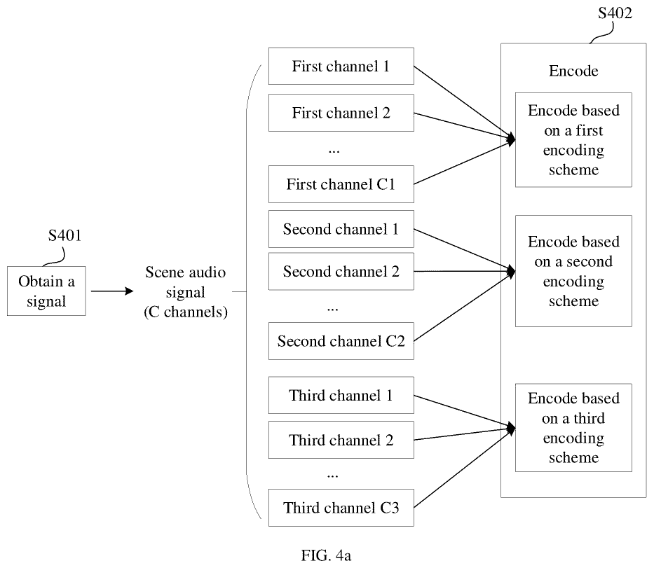

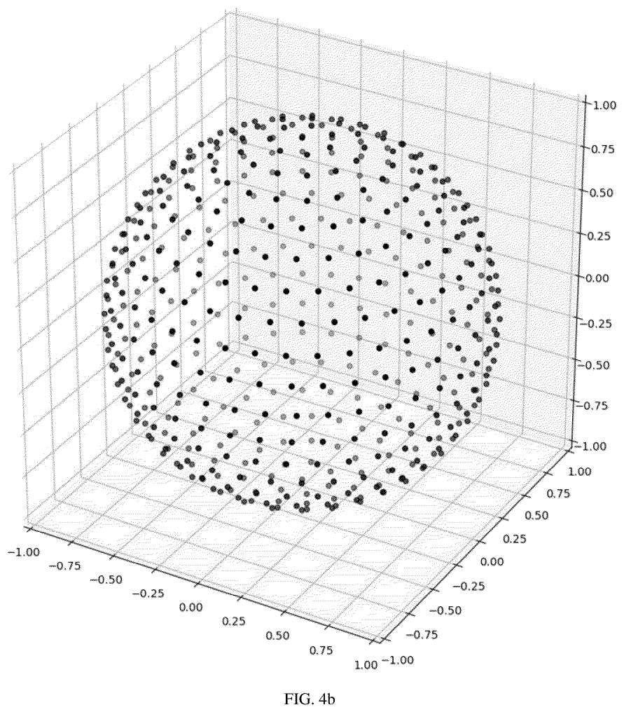

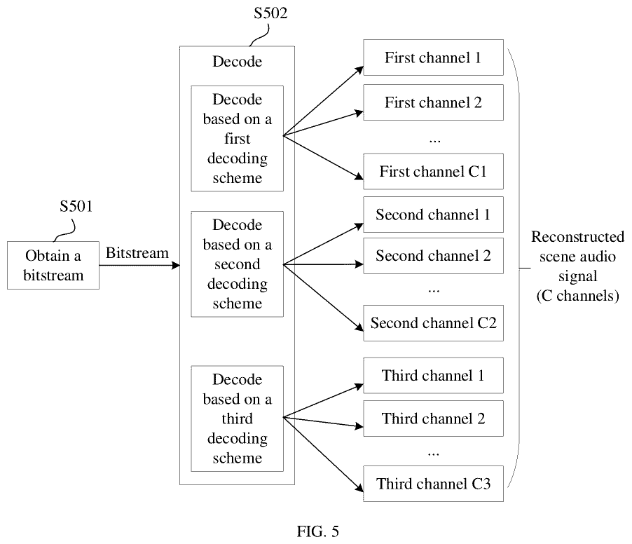

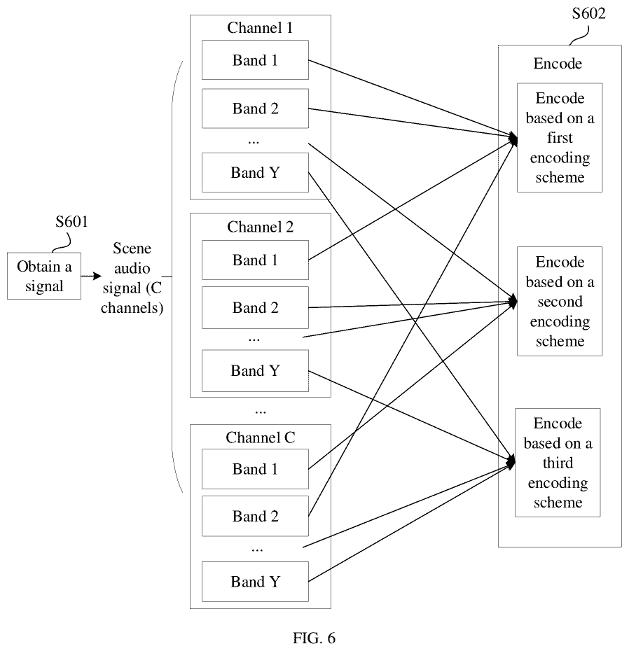

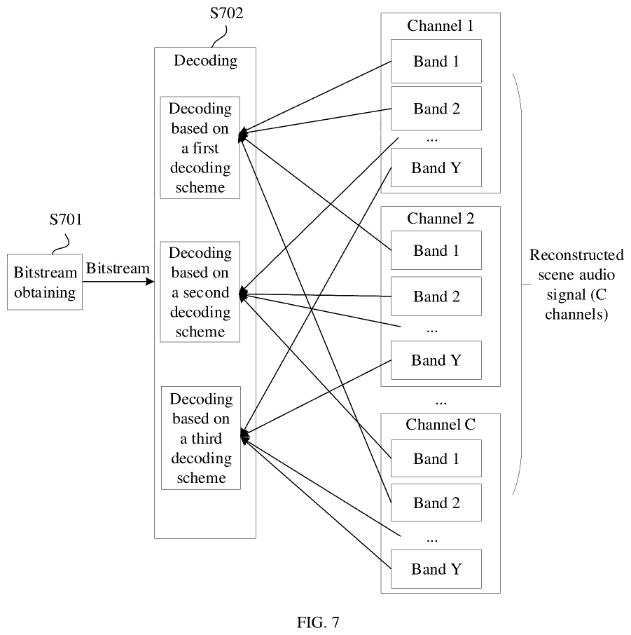

In a possible manner, when a to-be-encoded scene audio signal includes one frame, the frame of scene audio signal may be encoded by using a plurality of encoding schemes in tan encoding scheme combination. Refer to the following descriptions of an embodiment of FIG. 4a or an embodiment of FIG. 6. Correspondingly, a decoder receives a frame of bitstream, and decodes the frame of bitstream by using a plurality of decoding schemes in a decoding scheme combination, to obtain a frame of reconstructed scene audio signal. Refer to the following descriptions of an embodiment of FIG. 5 or an embodiment of FIG. 7.

In a possible manner, when a to-be-encoded scene audio signal includes a plurality of frames, each frame of scene audio signal may be encoded by using a plurality of encoding schemes in an encoding scheme combination. Refer to the following descriptions of an embodiment of FIG. 4a or an embodiment of FIG. 6. Correspondingly, a decoder receives a plurality of frames of bitstreams, and decodes each frame of bitstream by using a plurality of decoding schemes in a decoding scheme combination, to obtain a frame of reconstructed scene audio signal. Refer to the following descriptions of an embodiment of FIG. 5 or an embodiment of FIG. 7.

Encoding and decoding processes of a frame of scene audio signal are described below by using an example in which a third encoding scheme is a de-correlation encoding scheme.

FIG. 4a is a diagram of an example scene audio encoding process. In the embodiment of FIG. 4a, a plurality of channels in a frame of scene audio signal are encoded by using a plurality of encoding schemes in an encoding scheme combination. The encoding scheme combination is a combination of a first encoding scheme, a second encoding scheme, and a third encoding scheme.

S401: Obtain a scene audio signal, where the scene audio signal includes audio signals of C channels.

S402: For the scene audio signal, encode C1 first channels by using the first encoding scheme, encode C2 second channels by using the second encoding scheme, and encode C3 third channels by using the third encoding scheme.

For example, for a frame of scene audio signal, C1 first channels to be encoded by using the first encoding scheme, C2 second channels to be encoded by using the second encoding scheme, and C3 third channels to be encoded by using the third encoding scheme among C channels included in the frame of scene audio signal may be determined. C is equal to a sum of C1, C2, and C3, and C, C1, C2, and C3 are positive integers. The first channel, the second channel, and the third channel are different channels.

Then, the C1 first channels are encoded by using the first encoding scheme, the C2 second channels are encoded by using the second encoding scheme, and the C3 third channels are encoded by using the third encoding scheme, to obtain a bitstream of the frame of scene audio signal.

For example, a process of encoding the C1 first channels by using the first encoding scheme may be: directly encoding audio signals of the C1 first channels, to be specific, performing operations such as time-frequency transformation, preprocessing, bit allocation, quantization, and entropy encoding on the audio signals of the C1 first channels, to obtain encoded data of the audio signals of the C1 first channels.

For example, a process of encoding the C2 second channels by using the second encoding scheme may be: determining attribute information of a target virtual speaker based on the scene audio signal; and encoding the attribute information of the target virtual speaker.

For example, a virtual speaker is a speaker that is virtual, and is not a speaker that actually exists.

For example, it can be learned from the foregoing descriptions that the scene audio signal may be expressed through superposition of a plurality of plane waves, and then a target virtual speaker used to simulate a sound source in the scene audio signal may be determined. In this way, during subsequent decoding, a virtual speaker signal corresponding to the target virtual speaker is used to reconstruct the scene audio signal.

In a possible manner, a plurality of candidate virtual speakers at different locations may be set on a spherical surface, and then a target virtual speaker whose location matches a location of the sound source in the scene audio signal may be selected from the plurality of candidate virtual speakers.

FIG. 4b is a diagram of example distribution of candidate virtual speakers. In FIG. 4b, a plurality of candidate virtual speakers may be evenly distributed on a spherical surface, and one point on the spherical surface represents one candidate virtual speaker.

It should be noted that a quantity and distribution of candidate virtual speakers are not limited in this application, and may be set according to a requirement. Details are described below.

For example, a target virtual speaker whose location corresponds to the location of the sound source in the scene audio signal may be selected from the plurality of candidate virtual speakers based on the scene audio signal. There may be one or more target virtual speakers. This is not limited in this application. For details, refer to S11 to S13.

S11: Obtain a plurality of groups of virtual speaker coefficients corresponding to a plurality of candidate virtual speakers, where the plurality of groups of virtual speaker coefficients are in a one-to-one correspondence with the plurality of candidate virtual speakers.

For example, first configuration information of an encoding module (for example, a scene audio encoding module) may be obtained; then second configuration information of a candidate virtual speaker is determined based on the first configuration information of the encoding module; and then the plurality of candidate virtual speakers are generated based on the second configuration information of the candidate virtual speaker.

For example, the first configuration information includes but is not limited to an encoding bit rate and user-defined information (for example, an HOA order corresponding to the encoding module (an order of an HOA signal that can be encoded by the encoding module), an order of a reconstructed scene audio signal (an expected order of a reconstructed HOA signal obtained by a decoder through decoding), or a format of a reconstructed scene audio signal (an expected format of a reconstructed HOA signal obtained by a decoder through decoding)). This is not limited in this application.

For example, the second configuration information includes but is not limited to the following information: a total quantity of candidate virtual speakers, an HOA order of each candidate virtual speaker, location information of each candidate virtual speaker, and the like. This is not limited in this application.

For example, the second configuration information of the candidate virtual speaker may be determined based on the first configuration information of the encoding module in a plurality of manners. For example, a small quantity of candidate virtual speakers may be configured if the encoding bit rate is low; or a large quantity of candidate virtual speakers may be configured if the encoding bit rate is high. For another example, the HOA order of the virtual speaker may be set to the HOA order of the encoding module. In this embodiment of this application, in addition to determining the second configuration information of the candidate virtual speaker based on the first configuration information of the encoding module, the second configuration information of the candidate virtual speaker may alternatively be determined based on the user-defined information (for example, the total quantity of candidate virtual speakers, the HOA order of each candidate virtual speaker, and the location information of each candidate virtual speaker that may be defined by a user). This is not limited.

For example, a configuration table may be preset. The configuration table includes a relationship between a quantity of candidate virtual speakers and location information of the candidate virtual speakers. In this way, after the total quantity of candidate virtual speakers is determined, the location information of each candidate virtual speaker may be determined by searching the configuration table.

For example, after the second configuration information of the candidate virtual speaker is determined, the plurality of candidate virtual speakers may be generated based on the second configuration information of the candidate virtual speaker. For example, a corresponding quantity of candidate virtual speakers may be generated based on the total quantity of candidate virtual speakers, an HOA order of each candidate virtual speaker is set based on the HOA order of each candidate virtual speaker, and a location of each candidate virtual speaker is set based on the location information of each candidate virtual speaker.

For example, when each candidate virtual speaker serves as a virtual sound source, a virtual speaker signal generated by the virtual sound source is a plane wave, and the plane wave may be expanded in a spherical coordinate system. A form of an ideal plane wave that has an amplitude of S and a direction of (θₛ,φₛ) and that is expanded by using a spherical harmonic function may be shown in the formula (3). The HOA order of the candidate virtual speaker is a truncated value of m in the formula (3).

Then a virtual speaker coefficient corresponding to each candidate virtual speaker may be determined based on the HOA order of each candidate virtual speaker (each candidate virtual speaker corresponds to a group of virtual speaker coefficients). For example, for a candidate virtual speaker, with reference to the formula (3), the truncated value of m in the formula (3) is set to an HOA order of the candidate virtual speaker, and (θₛ,φₛ) in the formula (3) is set to location information (θₛ₃,φₛ₃) of the candidate virtual speaker. In this case,

$${B}_{m , n}^{σ}$$

shown in the formula (3) is a group of virtual speaker coefficients. (The virtual speaker coefficients are also HOA coefficients. It should be noted that, it can be learned from the formula (3) that when a location of the candidate virtual speaker is different from a location of a sound source in the scene audio signal, the virtual speaker coefficients of the candidate virtual speaker and the scene audio signal are different HOA coefficients.) In this way, a group of virtual speaker coefficients corresponding to each candidate virtual speaker can be determined.

S12: Select a target virtual speaker from the plurality of candidate virtual speakers based on the scene audio signal and the plurality of groups of virtual speaker coefficients.

For example, an inner product between the scene audio signal and each of the plurality of groups of virtual speaker coefficients is obtained, to obtain a plurality of inner product values. The plurality of inner product values are in a one-to-one correspondence with the plurality of groups of virtual speaker coefficients. For example, for each of the plurality of candidate virtual speakers, an inner product between a group of virtual speaker coefficients corresponding to the candidate virtual speaker and the scene audio signal may be obtained, to obtain a corresponding inner product value.

Then the target virtual speaker may be selected from the plurality of candidate virtual speakers based on the plurality of inner product values. In a possible manner, the first G (G is a positive integer) candidate virtual speakers with largest inner product values may be selected as target virtual speakers. In a possible manner, a candidate virtual speaker with a largest inner product may be first selected as a target virtual speaker. Then the scene audio signal is projected and superposed on a linear combination of a group of virtual speaker coefficients corresponding to the candidate virtual speaker with the largest inner product, to obtain a projection vector. Then the projection vector is subtracted from the scene audio signal to obtain a difference. Then the foregoing process is repeated on the difference to implement iterative calculation. One target virtual speaker is generated through each iteration.

S13: Obtain attribute information of the target virtual speaker.

In a possible manner, the attribute information of the target virtual speaker is generated based on location information of the target virtual speaker. In a possible manner, the location information (including pitch information and azimuth information) of the target virtual speaker may be used as the attribute information of the target virtual speaker. In a possible manner, a location index (including a pitch index (which may be used to uniquely identify pitch information) and an azimuth index (which may be used to uniquely identify azimuth information)) corresponding to the location information of the target virtual speaker is used as the attribute information of the target virtual speaker.

In a possible manner, a virtual speaker index (for example, a virtual speaker identifier) of the target virtual speaker may be used as the attribute information of the target virtual speaker. Virtual speaker indexes are in a one-to-one correspondence with location information.

In a possible manner, a virtual speaker coefficient of the target virtual speaker may be used as the attribute information of the target virtual speaker. For example, C virtual speaker coefficients of the target virtual speaker may be determined, and the C virtual speaker coefficients of the target virtual speaker are used as the attribute information of the target virtual speaker. The C virtual speaker coefficients of the target virtual speaker are in a one-to-one correspondence with audio signals of C channels included in a first reconstructed scene audio signal.

It should be noted that a data amount of the virtual speaker coefficient is far greater than a data amount of the location information, a data amount of the index of the location information, and a data amount of the virtual speaker index. Specific information, among the location information, the index of the location information, the virtual speaker index, and the virtual speaker coefficient, that is used as the attribute information of the target virtual speaker may be determined based on bandwidth. For example, when the bandwidth is high, the virtual speaker coefficient may be used as the attribute information of the target virtual speaker. In this way, the decoder does not need to calculate the virtual speaker coefficient of the target virtual speaker, so that computing power of the decoder can be saved. When the bandwidth is low, any one of the location information, the index of the location information, and the virtual speaker index may be used as the attribute information of the target virtual speaker. In this way, a bit rate can be reduced. It should be understood that specific information, among the location information, the index of the location information, the virtual speaker index, and the virtual speaker coefficient, that is used as the attribute information of the target virtual speaker may alternatively be preset. This is not limited in this application.

In a possible manner, the target virtual speaker may be preset.

It should be understood that neither of a manner of determining the target virtual speaker and a manner of determining the attribute information of the target virtual speaker is limited in this application.

For example, when the third encoding scheme is the de-correlation encoding scheme, encoding the C3 third channels by using the third encoding scheme may be as follows: Audio signals of the C3 third channels are not processed; instead, the decoder performs the de-correlation decoding scheme on the C3 third channels to determine reconstructed audio signals of the C3 third channels.

In a possible manner, the de-correlation encoding scheme may include a time-domain de-correlation encoding scheme and a frequency-domain de-correlation encoding scheme. When the third encoding scheme is the de-correlation encoding scheme, encoding the C3 third channels by using the third encoding scheme may be as follows: Whether the third encoding scheme is the time-domain de-correlation encoding scheme or the frequency-domain de-correlation encoding scheme is determined for the C3 third channels. When the third encoding scheme is the time-domain de-correlation encoding scheme, audio signals of the C3 third channels may not be processed; instead, a value of a first preset identifier is set to a first preset value, and a first preset identifier corresponding to the C3 third channels is encoded. The first preset identifier that is set to the first preset value indicates that the third encoding scheme of the C3 third channels is the time-domain de-correlation encoding scheme. When the third encoding scheme is the frequency-domain de-correlation encoding scheme, audio signals of the C3 third channels may not be processed; instead, a value of a first preset identifier is set to a second preset value, and a first preset identifier corresponding to the C3 third channels may be encoded. The first preset identifier that is set to the second preset value indicates that the third encoding scheme of the C3 third channels is the frequency-domain de-correlation encoding scheme. In this way, the decoder can learn of whether the third encoding scheme is the time-domain de-correlation encoding scheme or the frequency-domain de-correlation encoding scheme, and then perform decoding by using an algorithm of a corresponding de-correlation decoding scheme.

How to determine the C1 first channels, the C2 second channels, and the C3 third channels is described below by using an example in which the scene audio signal is an N^{th}-order HOA signal.

For example, the C1 first channels may be C1 channels included in the 0^{th} order to an M^{th} order of the N^{th}-order HOA signal, where M is an integer less than N, C is equal to a square of (N+1), and C1 is less than or equal to a square of (M+1).

For example, the C2 second channels may include: other C4 channels included in the 0^{th} order to the M^{th} order of the N^{th}-order HOA signal, and C5 channels in the N^{th}-order HOA signal other than channels included in the 0^{th} order to the M^{th} order.

For example, the C3 third channels may include: other C6 channels included in the 0th order to the M^{th} order of the N^{th}-order HOA signal, and C7 channels in the N^{th}-order HOA signal other than the channels included in the 0^{th} order to the M^{th} order.

C2=C4+C5, C3=C6+C7, C1+C4+C6=(M+1) 2, and C4, C5, C6, and C7 are integers.

Assuming that N=3, C=16. To be specific, the third-order HOA signal includes 16 channels.

When a value of n in the formula (3) is 0, one monomial may be obtained by expanding the formula (3), as shown in the following formula (5). In this case, an audio signal of one channel (subsequently referred to as a channel 1) may be obtained. When a value of n in the formula (3) is 1, three monomials may be obtained by expanding the formula (3), as shown in the following formula (6). In this case, audio signals of three channels (sequentially referred to as a channel 2, a channel 3, and a channel 4) may be obtained. When a value of n in the formula (4) is 2, five monomials may be obtained by expanding the formula (3), as shown in the following formula (7). In this case, audio signals of five channels (sequentially referred to as a channel 5, a channel 6, a channel 7, a channel 8, and a channel 9) may be obtained. When a value of n in the formula (4) is 3, seven monomials may be obtained by expanding the formula (3), as shown in the following formula (8). In this case, audio signals of seven channels (sequentially referred to as a channel 10, a channel 11, a channel 12, a channel 13, a channel 14, a channel 15, and a channel 16) may be obtained. Each monomial corresponds to one channel, and each monomials may represent an audio signal of one channel.

$$B {1}_{3 , 0}^{0} = s \cdot {Y}_{3 , 0}^{0} ( {θ}_{s 1} , {φ}_{s 1} ) \qquad ( 5 )$$

$$B {1}_{3 , 1}^{0} = s \cdot {Y}_{3 , 1}^{0} ( {θ}_{s 1} , {φ}_{s 1} ) , B {1}_{3 , 1}^{- 1} = s \cdot {Y}_{3 , 1}^{- 1} ( {θ}_{s 1} , {φ}_{s 1} ) , B {1}_{3 , 1}^{1} = s \cdot {Y}_{3 , 1}^{1} ( {θ}_{s 1} , {φ}_{s 1} ) \qquad ( 6 )$$

$$B {1}_{3 , 2}^{0} = s \cdot {Y}_{3 , 2}^{0} ( {θ}_{s 1} , {φ}_{s 1} ) , B {1}_{3 , 2}^{- 1} = s \cdot {Y}_{3 , 2}^{- 1} ( {θ}_{s 1} , {φ}_{s 1} ) , B {1}_{3 , 2}^{1} = s \cdot {Y}_{3 , 2}^{1} ( {θ}_{s 1} , {ϕ}_{s 1} ) , \qquad ( 7 )$$

$$B {1}_{3 , 2}^{- 2} = s \cdot {Y}_{3 , 2}^{- 2} ( {θ}_{s 1} , {φ}_{s 1} ) , B {1}_{3 , 2}^{2} = s \cdot {Y}_{3 , 2}^{2} ( {θ}_{s 1} , {φ}_{s 1} )$$

$$B {1}_{3 , 3}^{0} = s \cdot {Y}_{3 , 3}^{0} ( {θ}_{s 1} , {φ}_{s 1} ) , B {1}_{3 , 3}^{- 1} = s \cdot {Y}_{3 , 3}^{- 1} ( {θ}_{s 1} , {φ}_{s 1} ) , B {1}_{3 , 3}^{1} = s \cdot {Y}_{3 , 3}^{1} ( {θ}_{s 1} , {φ}_{s 1} ) , \qquad ( 8 )$$

$$B {1}_{3 , 3}^{- 2} = s \cdot {Y}_{3 , 3}^{- 2} ( {θ}_{s 1} , {φ}_{s 1} ) , B {1}_{3 , 3}^{2} = s \cdot {Y}_{3 , 3}^{2} ( {θ}_{s 1} , {φ}_{s 1} ) , B {1}_{3 , 3}^{- 3} = s \cdot {Y}_{3 , 3}^{- 3} ( {θ}_{s 1} , {φ}_{s 1} ) ,$$

$$B {1}_{3 , 3}^{3} = s \cdot {Y}_{3 , 3}^{3} ( {θ}_{s 1} , {φ}_{s 1} )$$

(θₛ₁,φₛ₁) is location information of the sound source in the scene audio signal.

For example, if M=0, to be specific, m in the formula (3) is 0, a value of n may be 0. One monomial may be obtained by expanding the formula (3). To be specific, the 0^{th} order in the third-order HOA signal includes one channel: the channel 1. In this case, C1=1, to be specific, the first channel is the channel 1, C4-0, and C6-0. Correspondingly, in addition to the channel included in the 0^{th} order, the third-order HOA signal further includes other 15 channels: the channel 2 to the channel 16. C5 channels may be selected from the 15 channels as second channels, and C7 channels may be selected as third channels.

An example is provided below:

It is assumed that C5=14, and C7=1. In this case, the C2 second channels are the channel 2 to the channel 15, and the C3 third channels are the channel 16; or the C2 second channels are the channel 2 to the channel 13, and the channel 16, and the C3 third channels are the channel 15. This may be set according to a requirement. This is not limited in this application.

For example, if M=1, to be specific, m in the formula (3) is 1, a value of n may be 0 or 1. Four monomials may be obtained by expanding the formula (3). To be specific, the 0^{th} order and the 1^{st} order in the third-order HOA signal include four channels: the channel 1 to the channel 4. In this case, the C1 first channels may be selected from the four channels, other C4 channels may be selected as second channels, and other C6 channels may be selected as third channels. Correspondingly, in addition to the channels included in the 0^{th} order and the 1^{st} order, the third-order HOA signal further includes other 12 channels: the channel 5 to the channel 16. C5 channels may be selected from the 12 channels as second channels, and C7 channels may be selected as third channels.

An example is provided below:

It is assumed that C1=4, C4-0, C6-0, C5=10, and C7=2. In this case, the C1 first channels are the channel 1 to the channel 4, the C2 second channels are the channel 5 to the channel 14, and the C3 third channels are the channel 16 and the channel 15; or the C1 first channels are the channel 1 to the channel 4, the C2 second channels are the channel 5 to the channel 10, and the channel 13 to the channel 16, and the C3 third channels are the channel 11 and the channel 12. This may be set according to a requirement. This is not limited in this application.

For example, if M=2, to be specific, m in the formula (3) is 2, a value of n may be 0, 1, or 2. Nine monomials may be obtained by expanding the formula (3). To be specific, the 0^{th} order to the 2^{nd} order in the third-order HOA signal include nine channels: the channel 1 to the channel 9. In this case, the C1 first channels may be selected from the nine channels, other C4 channels may be selected as second channels, and other C6 channels may be selected as third channels. Correspondingly, in addition to the channels included in the 0^{th} order to the 2^{nd} order, the third-order HOA signal further includes other seven channels: the channel 10 to the channel 16. C5 channels may be selected from the seven channels as second channels, and C7 channels may be selected as third channels.

An example is provided below:

For example, C1=8, C4=1, C6-0, C5=5, and C7=2. In this case, the C1 first channels include the channel 1 to the channel 5, and the channel 7 to the channel 9; the C2 second channels include the channel 6, and the channel 11 to the channel 15; and the C3 third channels include the channel 10 and the channel 16. Correspondingly, encoding schemes corresponding to the 16 channels may be indicated by a “Sub-combination 2” in the third column in Table 1.

For example, C1=9, C4=0, C6=0, C5=5, and C7=2. In this case, the C1 first channels include the channel 1 to the channel 9, the C2 second channels include the channel 11 to the channel 15, and the C3 third channels include the channel 10 and the channel 16. Correspondingly, encoding schemes corresponding to the 16 channels may be indicated by a “Sub-combination 3” in the third column in Table 1.

It should be understood that C1, C2, and C3 may be set to other values, and the first channel, the second channel, and the third channel may be selected in another manner. In this way, for 16 channels in a frame of scene audio signal, r (r is a positive integer greater than or equal to 2) sub-combinations can be obtained. This is not limited in this application.

TABLE 1

| | | | | | |
|---|---|---|---|---|---|
| Channel | Sub-combination 1 | Sub-combination 2 | Sub-combination 3 | . . . | Sub-combination r |

| | | | |
|---|---|---|---|
| 1 | Direct encoding | Direct encoding | Direct encoding |
| | scheme | scheme | scheme |
| 2 | De-correlation | Direct encoding | Direct encoding |
| | encoding scheme | scheme | scheme |
| 3 | De-correlation | Direct encoding | Direct encoding |
| | encoding scheme | scheme | scheme |
| 4 | De-correlation | Direct encoding | Direct encoding |
| | encoding scheme | scheme | scheme |
| 5 | De-correlation | Direct encoding | Direct encoding |
| | encoding scheme | scheme | scheme |
| 6 | De-correlation | Spatial encoding | Direct encoding |
| | encoding scheme | scheme | scheme |
| 7 | De-correlation | Direct encoding | Direct encoding |
| | encoding scheme | scheme | scheme |
| 8 | De-correlation | Direct encoding | Direct encoding |
| | encoding scheme | scheme | scheme |
| 9 | De-correlation | Direct encoding | Direct encoding |
| | encoding scheme | scheme | scheme |
| 10 | De-correlation | De-correlation | De-correlation |
| | encoding scheme | encoding scheme | encoding scheme |
| 11 | De-correlation | Spatial encoding | Spatial encoding |
| | encoding scheme | scheme | scheme |
| 12 | De-correlation | Spatial encoding | Spatial encoding |
| | encoding scheme | scheme | scheme |
| 13 | De-correlation | Spatial encoding | Spatial encoding |
| | encoding scheme | scheme | scheme |
| 14 | De-correlation | Spatial encoding | Spatial encoding |
| | encoding scheme | scheme | scheme |
| 15 | De-correlation | Spatial encoding | Spatial encoding |
| | encoding scheme | scheme | scheme |
| 16 | De-correlation | De-correlation | De-correlation |
| | encoding scheme | encoding scheme | encoding scheme |

For example, when the encoding scheme combination is a combination of the first encoding scheme and the third encoding scheme, C8 fourth channels may be encoded by using the first encoding scheme, and C9 fifth channels may be encoded by using the third encoding scheme.

The C8 fourth channels are C8 channels included in the 0^{th} order to the M^{th} order of the N^{th}-order HOA signal, where M is an integer less than N, C is equal to (N+1)², and C8 is less than or equal to (M+1)². The C9 fifth channels include: other C10 channels included in the 0^{th} order to the M^{th} order of the N^{th}-order HOA signal, and channels in the N^{th}-order HOA signal other than the channels included in the 0^{th} order to the M^{th} order, where C8+C10 is equal to (M+1)².

For example, if M=0, to be specific, m in the formula (3) is 0, a value of n may be 0. One monomial may be obtained by expanding the formula (3). To be specific, the 0^{th} order in the third-order HOA signal includes one channel: the channel 1. In this case, C8=1, to be specific, the fourth channel is the channel 1, and C10=0. Correspondingly, in addition to the channel included in the 0^{th} order, the third-order HOA signal further includes other 15 channels: the channel 2 to the channel 16. All of the 15 channels are fifth channels. In this case, encoding schemes corresponding to the 16 channels may be indicated by a “Sub-combination 1” in the second column in Table 1.

For example, if M=1, to be specific, m in the formula (3) is 1, a value of n may be 0 or 1. Four monomials may be obtained by expanding the formula (3). To be specific, the 0^{th} order and the 1^{st} order in the third-order HOA signal include four channels: the channel 1 to the channel 4. In this case, C8 channels may be selected from the four channels as third channels, and other C10 channels may be selected as fifth channels. Correspondingly, in addition to the channels included in the 0^{th} order and the 1^{st} order, the third-order HOA signal further includes other 12 channels: the channel 5 to the channel 16. All of the 12 channels are fifth channels.

An example is provided below:

It is assumed that C8=4, C10-0, and C9=12. In this case, C1 fourth channels are the channel 1 to the channel 4, and C9 fifth channels are the channel 5 to the channel 16.

It is assumed that C8=2, C10=2, and C9=12. In this case, C1 fourth channels are the channel 1 to the channel 2, and C9 fifth channels are the channel 3 to the channel 16.

For example, if M=2, to be specific, m in the formula (3) is 2, a value of n may be 0, 1, or 2. Nine monomials may be obtained by expanding the formula (3). To be specific, the 0^{th} order to the 2^{nd} order in the third-order HOA signal include nine channels: the channel 1 to the channel 9. In this case, C8 channels may be selected from the nine channels as fourth channels, and other C10 channels may be selected as fifth channels. Correspondingly, in addition to the channels included in the 0^{th} order to the 2^{nd} order, the third-order HOA signal further includes other seven channels: the channel 10 to the channel 16. All of the seven channels are fifth channels.

An example is provided below:

For example, C8=8, C10=0, and C9=8. In this case, C8 fourth channels include the channel 1 to the channel 8, and C9 fifth channels include the channel 9 to the channel 16.

It should be noted that a value of M, values of C1 to C10, specific channels included in the C1 first channels, specific channels included in the C2 second channels, specific channels included in the C3 third channels, specific channels included in the C8 fourth channels, and specific channels included in the C9 fifth channels may be determined based on features of audio signals of different channels. Features of audio signals of different channels may include directions. Directions of audio signals of different channels may be shown in Table 2.

TABLE 2

| Channel | Direction |
|---|---|
| 1 | Omnidirectional |
| 2 | Y direction |
| 3 | Z direction |
| 4 | X direction |
| 5 | V direction |
| 6 | T direction |
| 7 | R direction |
| 8 | S direction |
| 9 | U direction |
| 10 | Q direction |
| 11 | O direction |
| 12 | M direction |
| 13 | K direction |
| 14 | L direction |
| 15 | N direction |
| 16 | P direction |

For example, C7 channels in which audio signals include longitudinal components greater than a threshold are selected, as third channels, from the channels in the N^{th}-order HOA signal other than the channels included in the 0^{th} order to the M^{th} order. For example, audio signals of the channel 10 and the channel 16 include longitudinal components greater than the threshold. In this case, the channel 10 and the channel 16 are selected as third channels, as indicated by the “Sub-combination 2” and the “Sub-combination 3” in Table 1.

In a possible manner, a decoder and an encoder pre-agree upon an encoding scheme for encoding (or a decoding scheme for decoding) for each channel in a frame of scene audio signal.

In a possible manner, a decoder and an encoder do not pre-agree upon an encoding scheme for encoding (or a decoding scheme for decoding) for each channel in a frame of scene audio signal. In this case, the encoder may encode a fourth preset identifier, where the fourth preset identifier may indicate an encoding scheme corresponding to each channel. Optionally, the encoder may not need to encode a second preset identifier. In this way, after the fourth preset identifier is transmitted to the decoder, the decoder can perform decoding.

FIG. 5 is a diagram of an example scene audio decoding process. The embodiment of FIG. 5 is a decoding process corresponding to the encoding process in the embodiment of FIG. 4a.

S501: Receive a bitstream.

S502: Based on the bitstream, decode C1 first channels by using a first decoding scheme, decode C2 second channels by using a second decoding scheme, and decode C3 third channels by using a third decoding scheme, to obtain a frame of reconstructed scene audio signal.

For example, the reconstructed scene audio signal may include reconstructed audio signals of C channels. For a frame of reconstructed scene audio signal, C1 first channels to be decoded by using the first decoding scheme, C2 second channels to be decoded by using the second decoding scheme, and C3 third channels to be decoded by using the third decoding scheme among C channels included in the frame of reconstructed scene audio signal may be determined. C is equal to a sum of C1, C2, and C3, and C1, C2, and C3 are positive integers. The first channel, the second channel, and the third channel are different channels.

Then, based on the bitstream, the C1 first channels are decoded by using the first decoding scheme, the C2 second channels are decoded by using the second decoding scheme, and the C3 third channels are decoded by using the third decoding scheme, to obtain the reconstructed frame of scene audio signal.

For example, a process of decoding the C1 first channels based on the bitstream by using the first decoding scheme may be: parsing the bitstream to determine encoded data corresponding to audio signals of the C1 first channels; and then performing operations such as entropy decoding, dequantization, bit allocation, post-processing, and time-frequency transformation on the encoded data corresponding to the audio signals of the C1 first channels, to obtain reconstructed audio signals of the C1 first channels.

For example, a process of decoding the C2 second channels based on the bitstream by using the second decoding scheme may include the following S21 to S24, where C1 is equal to (M+1)².

S21: Determine, based on attribute information of a target virtual speaker, a first virtual speaker coefficient corresponding to the target virtual speaker.

For example, an encoder may write M into a first bitstream, and then M may be obtained from the first bitstream through decoding (certainly, the encoder and a decoder may alternatively pre-agree upon M, and this is not limited in this application). For example, when the attribute information of the target virtual speaker is location information, the location information of the target virtual speaker may be substituted into the foregoing formula (3), and m in the formula (3) is made to be equal to M, to obtain the first virtual speaker coefficient corresponding to the target virtual speaker. The first virtual speaker coefficient includes (M+1)² virtual speaker coefficients, and the (M+1)² virtual speaker coefficients correspond to C1 first channels.

For example, when the attribute information of the target virtual speaker is a location index of location information, the location information of the target virtual speaker may be determined based on a relationship between the location information and the location index, and then the first virtual speaker coefficient is determined in the foregoing manner.

For example, when the attribute information of the target virtual speaker is a virtual speaker index, location information of the target virtual speaker may be determined based on a relationship between the location information and the virtual speaker index, and then the first virtual speaker coefficient is determined in the foregoing manner.

For example, when the attribute information of the target virtual speaker is a virtual speaker coefficient, it can be learned from the foregoing descriptions that a group of virtual speaker coefficients corresponding to the target virtual speaker includes C virtual speaker coefficients. In this case, (M+1)² virtual speaker coefficients corresponding to (M+1)² channels included in reconstructed audio signals of C1 first channels may be selected as the first virtual speaker coefficient.

S22: Generate a virtual speaker signal based on the reconstructed audio signals of the C1 first channels and the first virtual speaker coefficient.

For example, the virtual speaker signal may be generated based on the reconstructed audio signals of the C1 first channels and the first virtual speaker coefficient.

For example, it is assumed that the first virtual speaker coefficient of the target virtual speaker is represented by a matrix A with a size of (Y1×P), where Y1 (Y1 is a positive integer) is a quantity of target virtual speakers, and P is a quantity (M+1)² of channels of audio signals included in the reconstructed audio signals of the C1 first channels. In addition, the reconstructed audio signals of the C1 first channels are represented by a matrix X with a size of (L×P), where L is a quantity of sampling points of the reconstructed audio signals of the C1 first channels. A theoretical optimal solution W is obtained by using a least square method, where W indicates the virtual speaker signal, as shown in a formula (9).

$$w = {A}^{- 1} X \qquad ( 9 )$$

The matrix A⁻¹ is an inverse matrix of the matrix A.

S23: Determine, based on the attribute information of the target virtual speaker, a second virtual speaker coefficient corresponding to the target virtual speaker.

For example, it may be determined, based on an expected order N of the reconstructed scene audio signal, that m in the foregoing formula (3) is equal to N. Then, when the attribute information of the target virtual speaker is the location information, the location information of the target virtual speaker may be substituted into the foregoing formula (3), and m in the formula (3) is made to be equal to N, to obtain the second virtual speaker coefficient. The second virtual speaker coefficient includes C virtual speaker coefficients, and the C virtual speaker coefficients correspond to the C channels in the reconstructed scene audio signal.

For example, when the attribute information of the target virtual speaker is a location index of location information, the location information of the target virtual speaker may be determined based on a relationship between the location information and the location index, and then the second virtual speaker coefficient is determined in the foregoing manner.

For example, when the attribute information of the target virtual speaker is a virtual speaker index, location information of the target virtual speaker may be determined based on a relationship between the location information and the virtual speaker index, and then the first virtual speaker coefficient is determined in the foregoing manner.

For example, when the attribute information of the target virtual speaker is the virtual speaker coefficient, the attribute information of the target virtual speaker may be directly used as the second virtual speaker coefficient.

S24: Obtain reconstructed audio signals of C2 second channels based on the virtual speaker signal and the second virtual speaker coefficient.

For example, it is assumed that the second virtual speaker coefficient is represented by a matrix A with a size of (Y1×C), where Y1 is a quantity of target virtual speakers, and C is a quantity of channels in the reconstructed scene audio signal. In addition, the virtual speaker signal is represented by a matrix B with a size of (L×Y1), where L is a quantity of sampling points of the reconstructed scene audio signal. In this case, a first reconstructed scene audio signal may be represented by H, as shown in a formula (10).

$$H = BA \qquad ( 10 )$$

Then reconstructed audio signals of C2 second channels may be selected from the first reconstructed scene audio signal.

In a possible manner, during encoding, feature information corresponding to the C2 second channel in the scene audio signal may alternatively be extracted, encoded, and sent to the decoder. After receiving the bitstream, the decoder may compensate for the reconstructed audio signals of the C2 second channels based on the feature information, to improve audio quality of the reconstructed audio signals of the C2 second channels in the reconstructed scene audio signal.

For example, gain information Gain(i) corresponding to the C2 second channels in the scene audio signal may be calculated according to the following formula (11):

$$Gain ( i ) = E ( i ) / E ( 1 ) \qquad ( 11 )$$

i is channel numbers of the C2 second channels, E(i) is energy of an i^{th} channel, and
E(1) is energy of audio signals of C channels in the scene audio signal.

For example, when the feature information is gain information, compensation may be performed according to the following formula (12):

$$E ( i ) = Gain ( i ) * E ( 1 ) \qquad ( 12 )$$

i is channel numbers of the C2 second channels, E(i) is energy of an i^{th} channel, E(1) is energy of reconstructed audio signals of C channels in the reconstructed scene audio signal, and Gain(i) is gain information corresponding to the C2 second channels in the scene audio signal.

In a possible manner, a process of decoding the C3 third channels based on the bitstream by using the third decoding scheme may be: processing reconstructed audio signals of one or more of the C1 first channels by using an all-pass filter, to obtain reconstructed audio signals of the C3 third channels.

For example, Table 1 is pre-synchronized between the decoder and the encoder, and correspondingly, the decoder stores Table 3 corresponding to Table 1.

TABLE 3

| | | | | | |
|---|---|---|---|---|---|
| Channel | Sub-combination 1 | Sub-combination 2 | Sub-combination 3 | . . . | Sub-combination r |

| | | | |
|---|---|---|---|
| 1 | Direct decoding | Direct decoding | Direct decoding |
| | scheme | scheme | scheme |
| 2 | De-correlation | Direct decoding | Direct decoding |
| | decoding scheme | scheme | scheme |
| 3 | De-correlation | Direct decoding | Direct decoding |
| | decoding scheme | scheme | scheme |
| 4 | De-correlation | Direct decoding | Direct decoding |
| | decoding scheme | scheme | scheme |
| 5 | De-correlation | Direct decoding | Direct decoding |
| | decoding scheme | scheme | scheme |
| 6 | De-correlation | Spatial decoding | Direct decoding |
| | decoding scheme | scheme | scheme |
| 7 | De-correlation | Direct decoding | Direct decoding |
| | decoding scheme | scheme | scheme |
| 8 | De-correlation | Direct decoding | Direct decoding |
| | decoding scheme | scheme | scheme |
| 9 | De-correlation | Direct decoding | Direct decoding |
| | decoding scheme | scheme | scheme |
| 10 | De-correlation | De-correlation | De-correlation |
| | decoding scheme | decoding scheme | decoding scheme |
| 11 | De-correlation | Spatial decoding | Spatial decoding |
| | decoding scheme | scheme | scheme |
| 12 | De-correlation | Spatial decoding | Spatial decoding |
| | decoding scheme | scheme | scheme |
| 13 | De-correlation | Spatial decoding | Spatial decoding |
| | decoding scheme | scheme | scheme |
| 14 | De-correlation | Spatial decoding | Spatial decoding |
| | decoding scheme | scheme | scheme |
| 15 | De-correlation | Spatial decoding | Spatial decoding |
| | decoding scheme | scheme | scheme |
| 16 | De-correlation | De-correlation | De-correlation |
| | decoding scheme | decoding scheme | decoding scheme |

In a possible manner, when the decoder and the encoder pre-agree upon an encoding scheme for encoding (or a decoding scheme for decoding) for each channel in a frame of scene audio signal, the decoder may perform decoding by using a decoding scheme that is pre-agreed upon for each channel in the frame of scene audio signal.

In a possible manner, when the decoder and the encoder do not pre-agree upon an encoding scheme for encoding (or a decoding scheme for decoding) for each channel in a frame of scene audio signal, the decoder may first parse the bitstream to obtain a fourth preset identifier; then determine a decoding scheme of each channel based on the fourth preset identifier; and then decode each frame of bitstream based on the decoding scheme of each channel, to obtain each frame of reconstructed scene audio signal. That is, for a same channel in a same frame, the encoder and the decoder perform encoding and decoding by using an encoding scheme and a decoding scheme that correspond to each other.

In a possible manner, an i^{th} frame of scene audio signal is encoded by using a plurality of encoding schemes in a k1^{th} encoding scheme combination, and a j^{th} frame of scene audio signal is encoded by using a plurality of encoding schemes in a k2^{th} encoding scheme combination, where i and j are positive integers ranging from 1 to X, i is not equal to j, k1 and k2 are positive integers, and k1 is not equal to k2. That is, different frames of scene audio signals are encoded by using a plurality of encoding schemes in different types of encoding scheme combinations.

Correspondingly, after receiving the bitstream, the decoder decodes an i^{th} frame of bitstream by using a plurality of decoding schemes in a k1^{th} decoding scheme combination to obtain an i^{th} frame of reconstructed scene audio signal, and decodes a j^{th} frame of bitstream by using a plurality of decoding schemes in a k2^{th} decoding scheme combination to obtain a j^{th} frame of reconstructed scene audio signal.

FIG. 6 is a diagram of an example scene audio encoding process. In the embodiment in FIG. 6, for a plurality of frequency bands of a same channel in a frame, encoding is performed by using a plurality of encoding schemes in an encoding scheme combination.

S601: Obtain a scene audio signal, where the scene audio signal includes audio signals of C channels, and an audio signal of a channel has Y frequency bands.

For example, an audio signal of each channel in a frame of scene audio signal may be divided into Y frequency bands, where Y may be set according to a requirement. This is not limited in this application.

For example, Y=2. To be specific, an audio signal of a channel may include a frequency band 1 and a frequency band 2, where a frequency of the frequency band 1 is less than a first frequency threshold, and a frequency of the frequency band 2 is greater than the first frequency threshold.

For example, Y=3. To be specific, an audio signal of a channel may include a frequency band 1, a frequency band 2, and a frequency band 3, where a frequency of the frequency band 1 is less than a first frequency threshold, a frequency of the frequency band 2 is greater than the first frequency threshold and less than a second frequency threshold, and a frequency of the frequency band 3 is greater than the second frequency threshold.

It should be noted that, for different channels, a quantity Y of frequency bands may vary, and a threshold used for division of frequency bands may also vary. This is not limited in this application. The first frequency threshold and the second frequency threshold may be set according to a requirement.

S602: For the Y frequency bands of the channel in the scene audio signal, perform encoding by using a plurality of encoding schemes in an encoding scheme combination.

One channel is used below as an example for description.

For example, when Y=2 and the encoding scheme combination is a combination of a first encoding scheme and a third encoding scheme, an audio signal on a frequency band 1 in the channel may be encoded by using the first encoding scheme, and an audio signal on a frequency band 2 in the channel may be encoded by using the third encoding scheme, as indicated by a sub-combination 1 in Table 4. Alternatively, an audio signal on a frequency band 1 in the channel is encoded by using the third encoding scheme, and an audio signal on a frequency band 2 in the channel is encoded by using the first encoding scheme.

For example, when Y=2 and the encoding scheme combination is a combination of a first encoding scheme, a second encoding scheme, and a third encoding scheme, an audio signal on a frequency band 1 in the channel may be encoded by using the first encoding scheme, and an audio signal on a frequency band 2 in the channel may be encoded by using the second encoding scheme, as indicated by a sub-combination 2 in Table 4. Alternatively, an audio signal on a frequency band 1 in the channel is encoded by using the second encoding scheme, and an audio signal on a frequency band 2 in the channel is encoded by using the third encoding scheme. Alternatively, an audio signal on a frequency band 1 in the channel is encoded by using the first encoding scheme, and an audio signal on a frequency band 2 in the channel is encoded by using the third encoding scheme.

For example, when Y=3 and the encoding scheme combination is a combination of a first encoding scheme and a third encoding scheme, audio signals on a frequency band 1 and a frequency band 2 in the channel may be encoded by using the first encoding scheme, and an audio signal on a frequency band 3 in the channel may be encoded by using the third encoding scheme, as indicated by a sub-combination 3 in Table 4. Alternatively, audio signals on a frequency band 1 and a frequency band 3 in the channel are encoded by using the first encoding scheme, and an audio signal on a frequency band 2 in the channel is encoded by using the third encoding scheme. Alternatively, audio signals on a frequency band 1 and a frequency band 2 in the channel are encoded by using the third encoding scheme, and an audio signal on a frequency band 3 in the channel is encoded by using the first encoding scheme.

For example, when Y=3 and the encoding scheme combination is a combination of a first encoding scheme, a second encoding scheme, and a third encoding scheme, an audio signal on a frequency band 1 in the channel may be encoded by using the first encoding scheme, an audio signal on a frequency band 2 in the channel may be encoded by using the second encoding scheme, and an audio signal on a frequency band 3 in the channel may be encoded by using the third encoding scheme, as indicated by a sub-combination 4 in Table 4. Alternatively, an audio signal on a frequency band 1 in the channel may be encoded by using the second encoding scheme, an audio signal on a frequency band 2 in the channel may be encoded by using the first encoding scheme, and an audio signal on a frequency band 3 in the channel may be encoded by using the third encoding scheme.

In this way, w (w is a positive integer) sub-combinations may be generated for one channel, and different encoding scheme combinations may include one or more sub-combinations.

TABLE 4

| | Sub- | Sub- | Sub- | Sub- | | |
|---|---|---|---|---|---|---|
| Frequency | combination | combination | combination | combination | | Sub- |
| band | 1 | 2 | 3 | 4 | . . . | combination w |

| | | | | |
|---|---|---|---|---|
| 1 | Direct | Direct | Direct | Direct |
| | encoding | encoding | encoding | encoding |
| | scheme | scheme | scheme | scheme |
| 2 | De- | Spatial | Direct | Spatial |
| | correlation | encoding | encoding | encoding |
| | encoding | scheme | scheme | scheme |
| | scheme | | | |
| 3 | | | De- | De- |
| | | | correlation | correlation |
| | | | encoding | encoding |
| | | | scheme | scheme |

In a possible manner, a decoder and an encoder may pre-agree upon an encoding scheme for encoding (or a decoding scheme for decoding) for Y frequency bands of one channel in a frame of scene audio signal.

In a possible manner, a decoder and an encoder do not pre-agree upon an encoding scheme for encoding (or a decoding scheme for decoding) for Y frequency bands of one channel in a frame of scene audio signal. In this case, the encoder may encode a fifth preset identifier, where the fifth preset identifier may indicate an encoding scheme corresponding to each frequency band of each channel. Optionally, the encoder may not need to encode a second preset identifier. In this way, after the fifth preset identifier is transmitted to the decoder, the decoder can perform decoding.

It should be understood that, for a plurality of frequency bands of different channels in a frame of scene audio signal, encoding may be performed by using a plurality of encoding schemes in different types of encoding scheme combinations. This is not limited in this application.

FIG. 7 is a diagram of an example scene audio decoding process. The embodiment of FIG. 7 is a decoding process corresponding to the encoding process in the embodiment of FIG. 6.

S701: Receive a bitstream.

For example, a reconstructed audio signal of each channel in a frame of reconstructed scene audio signal may be divided into Y frequency bands, where Y may be set according to a requirement. This is not limited in this application.

For example, Y=2. To be specific, a reconstructed audio signal of a channel may include a frequency band I and a frequency band 2, where a frequency of the frequency band 1 is less than a first frequency threshold, and a frequency of the frequency band 2 is greater than the first frequency threshold.

For example, Y=3. To be specific, a reconstructed audio signal of a channel may include a frequency band 1, a frequency band 2, and a frequency band 3, where a frequency of the frequency band 1 is less than a first frequency threshold, a frequency of the frequency band 2 is greater than the first frequency threshold and less than a second frequency threshold, and a frequency of the frequency band 3 is greater than the second frequency threshold.

It should be noted that, for different channels, a quantity Y of frequency bands may vary, and a threshold used for division of frequency bands may also vary. This is not limited in this application. The first frequency threshold and the first frequency threshold may be set according to a requirement.

It should be understood that a manner of dividing, by a decoder, each channel into frequency bands is the same as a manner of dividing, by an encoder, each channel into frequency bands.

S702: For Y frequency bands of a channel in a frame, decode a frame of bitstream by using a plurality of decoding schemes in a decoding scheme combination to obtain a frame of reconstructed scene audio signal.

One channel is used below as an example for description.

For example, when Y=2 and the decoding scheme combination is a combination of a first decoding scheme and a third decoding scheme, an audio signal on a frequency band 1 in the channel may be decoded by using the first decoding scheme, and an audio signal on a frequency band 2 in the channel may be decoded by using the third decoding scheme, as indicated by a sub-combination 1 in Table 5. Alternatively, an audio signal on a frequency band 1 in the channel is decoded by using the third decoding scheme, and an audio signal on a frequency band 2 in the channel is decoded by using the first decoding scheme.

For example, when Y=2 and the decoding scheme combination is a combination of a first decoding scheme, a second decoding scheme, and a third decoding scheme, an audio signal on a frequency band 1 in the channel may be decoded by using the first decoding scheme, and an audio signal on a frequency band 2 in the channel may be decoded by using the second decoding scheme, as indicated by a sub-combination 2 in Table 5. Alternatively, an audio signal on a frequency band 1 in the channel is decoded by using the second decoding scheme, and an audio signal on a frequency band 2 in the channel is decoded by using the third decoding scheme. Alternatively, an audio signal on a frequency band 1 in the channel is decoded by using the second decoding scheme, and an audio signal on a frequency band 2 in the channel is decoded by using the third decoding scheme.

For example, when Y=3 and the decoding scheme combination is a combination of a first decoding scheme and a third decoding scheme, audio signals on a frequency band 1 and a frequency band 2 in the channel may be decoded by using the first decoding scheme, and an audio signal on a frequency band 3 in the channel may be decoded by using the third decoding scheme, as indicated by a sub-combination 3 in Table 5. Alternatively, audio signals on a frequency band 1 and a frequency band 3 in the channel are decoded by using the first decoding scheme, and an audio signal on a frequency band 2 in the channel is decoded by using the third decoding scheme. Alternatively, audio signals on a frequency band 1 and a frequency band 2 in the channel are decoded by using the third decoding scheme, and an audio signal on a frequency band 3 in the channel is decoded by using the first decoding scheme.

For example, when Y=3 and the decoding scheme combination is a combination of a first decoding scheme, a second decoding scheme, and a third decoding scheme, an audio signal on a frequency band 1 in the channel may be decoded by using the first decoding scheme, an audio signal on a frequency band 2 in the channel may be decoded by using the second decoding scheme, and an audio signal on a frequency band 3 in the channel may be decoded by using the third decoding scheme, as indicated by a sub-combination 4 in Table 5. Alternatively, an audio signal on a frequency band 1 in the channel may be decoded by using the second decoding scheme, an audio signal on a frequency band 2 in the channel may be decoded by using the first decoding scheme, and an audio signal on a frequency band 3 in the channel may be decoded by using the third decoding scheme.

In this way, w (w is a positive integer) sub-combinations may be generated for one channel, and different decoding scheme combinations may include one or more sub-combinations.

TABLE 5

| | Sub- | Sub- | Sub- | Sub- | | |
|---|---|---|---|---|---|---|
| Frequency | combination | combination | combination | combination | | Sub- |
| band | 1 | 2 | 3 | 4 | . . . | combination w |

| | | | | |
|---|---|---|---|---|
| 1 | Direct | Direct | Direct | Direct |
| | decoding | decoding | decoding | decoding |
| | scheme | scheme | scheme | scheme |
| 2 | De- | Spatial | Direct | Spatial |
| | correlation | decoding | decoding | decoding |
| | decoding | scheme | scheme | scheme |
| | scheme | | | |
| 3 | | | De- | De- |
| | | | correlation | correlation |
| | | | decoding | decoding |
| | | | scheme | scheme |

In a possible manner, when the decoder and the encoder pre-agree upon an encoding scheme for encoding (or a decoding scheme for decoding) for Y frequency bands of one channel in a frame of scene audio signal, the decoder may perform decoding on a corresponding frequency band based on the pre-agreed-upon encoding scheme, to obtain a reconstructed audio signal of the channel.

In a possible manner, when the decoder and the encoder do not pre-agree upon an encoding scheme for encoding (or a decoding scheme for decoding) for Y frequency bands of a channel in a frame of scene audio signal, after receiving the bitstream, the decoder may first parse the bitstream to obtain a fifth preset identifier; then determine, based on the fifth preset identifier, a decoding scheme for each frequency band in Y frequency bands of each channel; and then decode the bitstream on the Y frequency bands of each channel based on a decoding scheme determined based on the fifth preset identifier, to obtain a reconstructed audio signal of the channel.

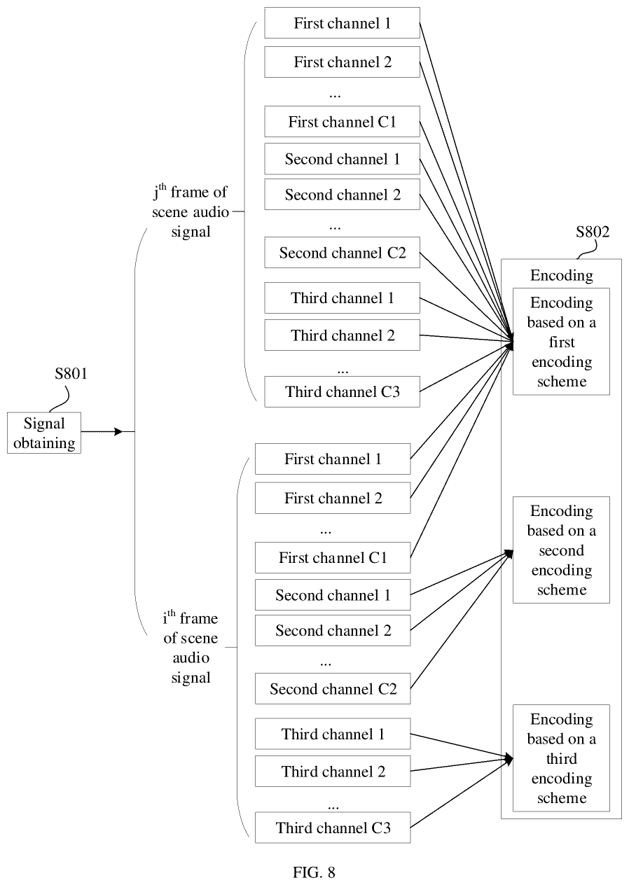

FIG. 8 is a diagram of an example scene audio encoding process. In the embodiment of FIG. 8, some frames are encoded by using a plurality of encoding schemes in an encoding scheme combination, and other frames are encoded by using a first encoding scheme in the encoding scheme combination.

S801: Obtain a scene audio signal.

S802: Encode an i^{th} frame of scene audio signal by using a plurality of encoding schemes in an encoding scheme combination.

For example, for S802, refer to the foregoing descriptions.

S803: Encode a j^{th} frame of scene audio signal by using a first encoding scheme in the encoding scheme combination.

i and j are positive integers ranging from 1 to X, i is not equal to j, k1 and k2 are positive integers, and k1 is not equal to k2.

For example, regardless of whether the encoding scheme combination is a combination of the first encoding scheme and a third encoding scheme or a combination of the first encoding scheme, a second encoding scheme, and a third encoding scheme, the j^{th} frame of scene audio signal is encoded by using the first encoding scheme in the encoding scheme combination.

It should be noted that, in this application, a quantity of frames of a scene audio signal encoded by using the first encoding scheme in the encoding scheme combination, and a quantity of frames of a scene audio signal encoded by using a plurality of encoding schemes in the encoding scheme combination are not limited. In addition, in this application, a specific frame encoded by using the first encoding scheme in the encoding scheme combination, and a specific frame encoded by using a plurality of encoding schemes in the encoding scheme combination are not limited.

In a possible manner, an encoder and a decoder may pre-agree upon specific frames to be encoded by using the first encoding scheme in the encoding scheme combination, and pre-agree upon specific frames to be encoded by using a plurality of encoding schemes in the encoding scheme combination.

In a possible manner, an encoder and a decoder do not pre-agree upon an encoding or decoding scheme for each frame. In this case, when the i^{th} frame of scene audio signal is encoded by using a plurality of encoding schemes in the encoding scheme combination, a second preset identifier (the second preset identifier indicates a type of an encoding scheme combination corresponding to each frame) is written into a bitstream of the i^{th} frame. When the j^{th} frame of scene audio signal is encoded by using the first encoding scheme in the encoding scheme combination, a sixth preset identifier is written into a bitstream of the j^{th} frame. The sixth preset identifier indicates that a current frame is encoded by using the first encoding scheme.

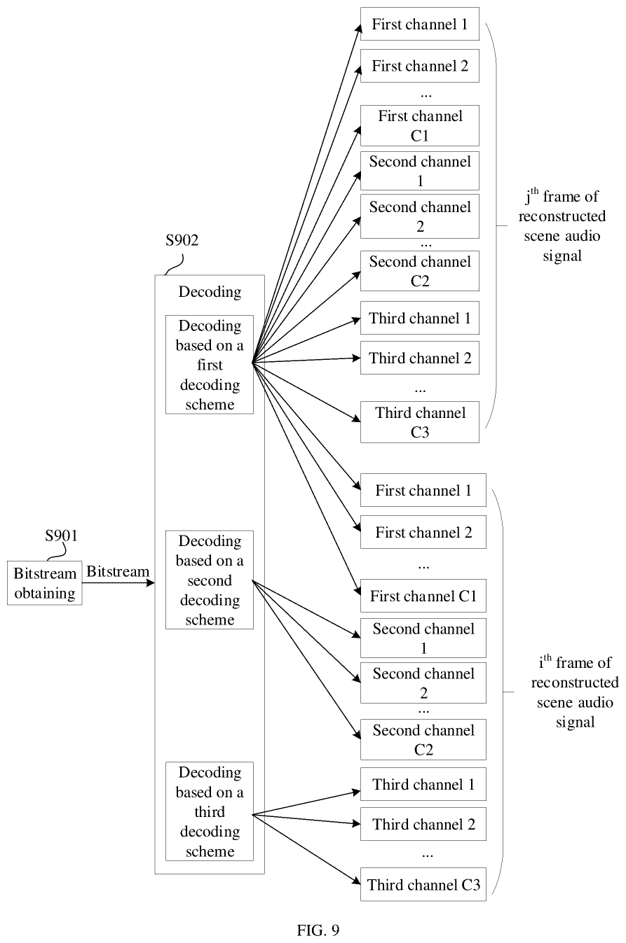

FIG. 9 is a diagram of an example scene audio decoding process. FIG. 9 is a decoding process corresponding to the encoding process in FIG. 8.

S901: Receive a bitstream.

S902: Decode an i^{th} frame of bitstream by using a plurality of decoding schemes in a decoding scheme combination to obtain an i^{th} frame of reconstructed scene audio signal. For example, for S902, refer to the foregoing descriptions.

S903: Decode a j^{th} frame of bitstream by using a first decoding scheme in the decoding scheme combination to obtain a j^{th} frame of reconstructed scene audio signal.

i and j are positive integers ranging from 1 to X, i is not equal to j, k1 and k2 are positive integers, and k1 is not equal to k2.

For example, regardless of whether the decoding scheme combination is a combination of the first decoding scheme and a third decoding scheme or a combination of the first decoding scheme, a second decoding scheme, and a third decoding scheme, the j^{th} frame of scene audio signal is decoded by using the first decoding scheme in the decoding scheme combination.

It should be noted that, in this application, a quantity of frames of a scene audio signal decoded by using the first decoding scheme in the decoding scheme combination, and a quantity of frames of a scene audio signal decoded by using a plurality of decoding schemes in the decoding scheme combination are not limited.

In a possible manner, when a decoder and an encoder pre-determine specific frames to be encoded by using a plurality of schemes in an encoding scheme combination, and specific frames to be encoded by using a first encoding scheme in the encoding scheme combination, the decoder may decode a bitstream by using a pre-agreed-upon encoding scheme, to obtain a reconstructed scene audio signal.

In a possible manner, when a decoder and an encoder do not pre-agree upon specific frames to be encoded by using a plurality of schemes in an encoding scheme combination, or specific frames to be encoded by using a first encoding scheme in the encoding scheme combination, after receiving a bitstream, when parsing out a second preset identifier from a frame of bitstream, the decoder may decode the frame of bitstream by using a plurality of decoding schemes in a decoding scheme combination corresponding to the second preset identifier, to obtain a frame of reconstructed scene audio signal. When the sixth preset identifier is parsed out from a frame of bitstream, the frame of bitstream may be decoded by using the first encoding scheme, to obtain a frame of reconstructed scene audio signal.

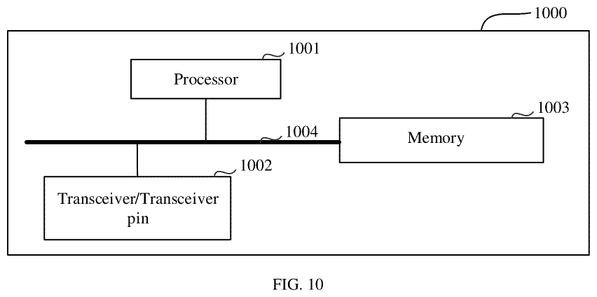

In an example, FIG. 10 is a block diagram of an apparatus 1000 according to an embodiment of this application. The apparatus 1000 may include a processor 1001 and a transceiver or transceiver pin 1002, and optionally, further includes a memory 1003.

Components of the apparatus 1000 are coupled together through a bus 1004. In addition to a data bus, the bus 1004 further includes a power bus, a control bus, and a status signal bus. However, for clarity of description, various buses are referred to as the bus 1004 in the figure.

Optionally, the memory 1003 may be configured to store instructions in the foregoing method embodiments. The processor 1001 may be configured to execute the instructions in the memory 1003, control a receive pin to receive a signal, and control a transmit pin to send a signal. When the processor 1001 is configured to execute the instructions in the memory 1003, an electronic device is enabled to perform the foregoing related method steps to implement the methods in the foregoing embodiments.

The apparatus 1000 may be the electronic device in the foregoing method embodiments or a chip of the electronic device.

The electronic device may be a terminal device or a server.

All related content of the steps in the foregoing method embodiments may be cited in function descriptions of corresponding functional modules.

An embodiment of this application further provides a chip, including one or more interface circuits and one or more processors. The one or more processors send or receive data through the one or more interface circuits. When the one or more processors execute computer instructions, an electronic device is enabled to perform the foregoing related method steps to implement the methods in the foregoing embodiments. The interface circuit is a transceiver/transceiver pin 1002.

An embodiment further provides a computer-readable storage medium. The computer-readable storage medium stores computer instructions. When the computer instructions are run on an electronic device, the electronic device is enabled to perform the foregoing related method steps to implement the methods in the foregoing embodiments.

An embodiment further provides a computer program product. The computer program product includes computer instructions. When the computer instructions are executed by a computer or a processor, the computer is enabled to perform the foregoing related steps to implement the methods in the foregoing embodiments.

In addition, an embodiment of this application further provides an apparatus. The apparatus may be a chip, a component, or a module. The apparatus may include a processor and a memory that are connected to each other. The memory is configured to store computer-executable instructions. When the apparatus runs, the processor may execute the computer-executable instructions stored in the memory, to enable the chip to perform the methods in the foregoing method embodiments.

The electronic device, the computer-readable storage medium, the computer program product, or the chip provided in embodiments is configured to perform the corresponding method provided above. Therefore, for beneficial effects that can be achieved, refer to the beneficial effects in the corresponding methods provided above.

Based on the descriptions of the foregoing implementations, a person skilled in the art may understand that, for ease and brevity of description, division into the foregoing functional modules is merely used as an example for illustration. During actual application, the foregoing functions may be allocated to different functional modules and implemented according to a requirement. In other words, an inner structure of the apparatus is divided into different functional modules to implement all or some of the functions described above.

In the several embodiments provided in this application, it should be understood that the disclosed apparatuses and methods may be implemented in other manners. For example, the described apparatus embodiments are merely examples. For example, division into the modules or the units is merely logical function division. During actual implementation, another division manner may be used. For example, a plurality of units or components may be combined or integrated into another apparatus, or some features may be ignored or not performed. In addition, the shown or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts shown as units may be one or more physical units, may be located in one place, or may be distributed in different places. Some or all of the units may be selected according to actual requirements to achieve the objectives of the solutions of embodiments.

In addition, functional units in embodiments of this application may be integrated into one processing unit, or each unit may exist alone physically, or two or more units may be integrated into one unit. The integrated unit may be implemented in a form of hardware, or may be implemented in a form of a software functional unit.

Any content in embodiments of this application and any content in a same embodiment may be combined in any manner. Any combination of the foregoing content falls within the scope of this application.

When the integrated unit is implemented in the form of a software functional unit and sold or used as an independent product, the integrated unit may be stored in a readable storage medium. Based on such an understanding, the technical solutions in embodiments of this application essentially, or the part contributing to the conventional technology, or all or some of the technical solutions may be implemented in a form of a software product. The software product is stored in a storage medium and includes several instructions for instructing a device (which may be a single-chip microcomputer, a chip, or the like) or a processor to perform all or some of the steps of the methods described in embodiments of this application. The storage medium includes any medium that can store program code, for example, a USB flash drive, a removable hard disk drive, a read-only memory (ROM), a random access memory (RAM), a magnetic disk, or a compact disc.

The foregoing describes embodiments of this application with reference to the accompanying drawings. However, this application is not limited to the foregoing specific implementations. The foregoing specific implementations are merely examples, but are not limitative. Inspired by this application, a person of ordinary skill in the art may further make many modifications without departing from the purposes of this application and the protection scope of the claims, and all the modifications shall fall within the protection of this application.

Methods or algorithm steps described with reference to the content disclosed in embodiments of this application may be implemented by hardware, or may be implemented by a processor executing software instructions. The software instructions may include corresponding software modules. The software modules may be stored in a random access memory (RAM), a flash memory, a read-only memory (ROM), an erasable programmable read-only memory (EPROM), an electrically erasable programmable read-only memory (EEPROM), a register, a hard disk drive, a removable hard disk drive, a compact disc read-only memory (CD-ROM), or any other form of storage medium well-known in the art. For example, a storage medium is coupled to a processor, so that the processor can read information from the storage medium and write information into the storage medium. Certainly, the storage medium may alternatively be a component of the processor. The processor and the storage medium may be located in an ASIC.

A person skilled in the art should be aware that, in the foregoing one or more examples, functions described in embodiments of this application may be implemented by hardware, software, firmware, or any combination thereof. When the functions are implemented by software, the foregoing functions may be stored in a computer-readable medium or transmitted as one or more instructions or code in a computer-readable medium. The computer-readable medium includes a computer-readable storage medium and a communication medium. The communication medium includes any medium suitable for transmitting a computer program from one place to another. The storage medium may be any available medium accessible to a general-purpose or dedicated computer.

The foregoing describes embodiments of this application with reference to the accompanying drawings. However, this application is not limited to the foregoing specific implementations. The foregoing specific implementations are merely examples, but are not limitative. Inspired by this application, a person of ordinary skill in the art may further make many modifications without departing from the purposes of this application and the protection scope of the claims, and all the modifications shall fall within the protection of this application.

1. A scene audio encoding method, comprising:
obtaining a scene audio signal; and
encoding the scene audio signal based on an encoding scheme combination, wherein
the encoding scheme combination comprises at least one of: a combination of a first encoding scheme, a second encoding scheme, and a third encoding scheme, or a combination of the first encoding scheme and the third encoding scheme, and
the first encoding scheme includes encoding a signal, the second encoding scheme includes a spatial encoding scheme, and the third encoding scheme includes an encoding scheme other than the first encoding scheme and the second encoding scheme.

2. The method according to claim 1, wherein the spatial encoding scheme is for encoding attribute information of a target virtual speaker, and the attribute information of the target virtual speaker is determined based on the scene audio signal.

3. The method according to claim 2, wherein the third encoding scheme comprises a channel copy encoding scheme, and the channel copy encoding scheme is a de-correlation encoding scheme.

4. The method according to claim 1, wherein encoding the scene audio signal based on the encoding scheme combination comprises:
encoding a frame of the scene audio signal by using a plurality of encoding schemes in the encoding scheme combination.

5. The method according to claim 4, wherein the frame of the scene audio signal comprises audio signals of C channels, and in association with the encoding scheme combination being the combination of the first encoding scheme, the second encoding scheme, and the third encoding scheme, encoding the frame of scene audio signal by using the plurality of encoding schemes in the encoding scheme combination comprises:
for the frame of scene audio signal, encoding C1 first channels by using the first encoding scheme, encoding C2 second channels by using the second encoding scheme, and encoding C3 third channels by using the third encoding scheme, wherein
C is equal to a sum of C1, C2, and C3, and C, C1, C2, and C3 are positive integers.

6. The method according to claim 5, wherein
the scene audio signal is an N^{th}-order higher-order ambisonics (HOA) signal,
the C1 first channels are C1 channels comprised in the 0^{th} order to an M^{th} order of the N^{th} order HOA signal, wherein M is an integer less than N, C is equal to a square of (N+1), and C1 is less than or equal to a square of (M+1),
the C2 second channels comprise: other C4 channels comprised in the 0^{th} order to the M^{th} order of the N^{th}-order HOA signal, and C5 channels in the N^{th}-order HOA signal other than channels comprised in the 0^{th} order to the M^{th} order,
the C3 third channels comprise: other C6 channels comprised in the 0^{th} order to the M^{th} order of the N^{th}-order HOA signal, and C7 channels in the N^{th}-order HOA signal other than the channels comprised in the 0^{th} order to the M^{th} order, and
C2 is equal to a sum of C4 and C5, C3 is equal to a sum of C6 and C7, a square of (M+1) is equal to a sum of C1, C4, and C6, and C4, C5, C6, and C7 are integers.

7. The method according to claim 5, wherein encoding the C3 third channels by using the third encoding scheme comprises:
encoding a first preset identifier corresponding to the C3 third channels, wherein the first preset identifier indicates the third encoding scheme of the C3 third channels is a time-domain de-correlation encoding scheme or a frequency-domain de-correlation encoding scheme.

8. The method according to claim 5, wherein in association with the encoding scheme combination being the combination of the first encoding scheme, the second encoding scheme, and the third encoding scheme, the method further comprises:
encoding feature information corresponding to the C2 second channels.

9. The method according to claim 1, wherein the scene audio signal comprises X frames having an i^{th} frame and a j^{th} frame, X is a positive integer, and encoding the scene audio signal based on the encoding scheme combination comprises:
encoding the i^{th} frame of scene audio signal by using a plurality of encoding schemes in the encoding scheme combination; and
encoding the j^{th} frame of scene audio signal by using the first encoding scheme in the encoding scheme combination, wherein
i and j are integers ranging from 1 to X, and i is not equal to j.

10. The method according to claim 1, wherein the scene audio signal comprises X frames, the X frames comprise an i^{th} frame and a j^{th} frame, X is a positive integer, and encoding the scene audio signal based on the encoding scheme combination comprises:
encoding the i^{th} frame of scene audio signal by using a plurality of encoding schemes in a k1^{th} encoding scheme combination; and
encoding the j^{th} frame of scene audio signal by using a plurality of encoding schemes in a k2^{th} encoding scheme combination, wherein
i and j are positive integers ranging from 1 to X, i is not equal to j, k1 is not equal to k2, and k1 and k2 are positive integers.

11. The method according to claim 4, wherein the frame of the scene audio signal comprises audio signals of C channels, an audio signal of a channel has Y frequency bands, and C and Y are positive integers, and
encoding the frame of scene audio signal by using the plurality of encoding schemes in the encoding scheme combination comprises:
for the Y frequency bands of the channel in the frame of scene audio signal, performing encoding by using the plurality of encoding schemes in the encoding scheme combination.

12. An electronic device, comprising:
a processor; and
a memory configured to store computer readable instructions that, when executed by the processor, cause the electronic device to:
obtain a scene audio signal; and
encode the scene audio signal based on an encoding scheme combination, wherein
the encoding scheme combination comprises at least one of: a combination of a first encoding scheme, a second encoding scheme, and a third encoding scheme, or a combination of the first encoding scheme and the third encoding scheme, and
the first encoding scheme includes encoding a signal, the second encoding scheme is a spatial encoding scheme, and the third encoding scheme is an encoding scheme other than the first encoding scheme and the second encoding scheme.

13. The electronic device according to claim 12, wherein the spatial encoding scheme is for encoding attribute information of a target virtual speaker, and the attribute information of the target virtual speaker is determined based on the scene audio signal.

14. The electronic device according to claim 12, wherein the third encoding scheme comprises a channel copy encoding scheme, and the channel copy encoding scheme is a de-correlation encoding scheme.

15. The electronic device according to claim 12, the electronic device is further caused to:
encode a frame of the scene audio signal by using a plurality of encoding schemes in the encoding scheme combination.

16. The electronic device according to claim 15, wherein the frame of scene audio signal comprises audio signals of C channels, and when the encoding scheme combination is the combination of the first encoding scheme, the second encoding scheme, and the third encoding scheme, the electronic device is further caused to:
for the frame of scene audio signal, encode C1 first channels by using the first encoding scheme, encode C2 second channels by using the second encoding scheme, and encode C3 third channels by using the third encoding scheme, wherein
C is equal to a sum of C1, C2, and C3, and C, C1, C2, and C3 are positive integers.

17. The electronic device according to claim 15, wherein the frame of the scene audio signal comprises audio signals of C channels, an audio signal of a channel has Y frequency bands, C and Y are positive integers, and the electronic device is further caused to:
for the Y frequency bands of the channel in the frame of scene audio signal, perform encoding by using the plurality of encoding schemes in the encoding scheme combination.

18. A non-transitory computer-readable storage medium configured to store a computer program, and when the computer program is run on a computer or a processor, the computer or the processor is caused to provide execution comprising:
obtaining a scene audio signal; and
encoding the scene audio signal based on an encoding scheme combination, wherein
the encoding scheme combination comprises at least one of: a combination of a first encoding scheme, a second encoding scheme, and a third encoding scheme, or a combination of the first encoding scheme and the third encoding scheme, and
the first encoding scheme includes encoding a signal, the second encoding scheme is a spatial encoding scheme, and the third encoding scheme is an encoding scheme other than the first encoding scheme and the second encoding scheme.

19. The non-transitory computer-readable storage medium according to claim 18, wherein the spatial encoding scheme is for encoding attribute information of a target virtual speaker, and the attribute information of the target virtual speaker is determined based on the scene audio signal.

20. The non-transitory computer-readable storage medium according to claim 18, wherein the third encoding scheme comprises a channel copy encoding scheme, and the channel copy encoding scheme is a de-correlation encoding scheme.
